(19) United States
(12) Patent Application Publication
(10) Pub. No.: US 2011/0160036 A1
(43) Pub. Date: Jun. 30, 2011

(54) VALVE METAL OXIDE FORMULATION

(75) Inventors: Benno Gries, Wolfenbuettel (DE); Joerg Laube, Laufenburg (DE); Rolf Wagner, Selp (DE)

(73) Assignee: H.C. Starck GMBH, Goslar (DE)

(21) Appl. No.: 13/060,437

(22) PCT Filed: Aug. 6, 2009
(86) PCT No.: PCT/EP09/60194

§ 371 Date: Mar. 17, 2011

(30) Foreign Application Priority Data
Aug. 26, 2008 (DE) 10 2008 039 668.0

(51) Int. Cl. C04B 35/48

(52) U.S. Cl. 501/134

(57) ABSTRACT

A formulation of at least one of a partially and a fully stabilized zirconium oxide powder includes at least one organic auxiliary substance wherein a pressing pressure so as to obtain a green density of at least 50% of a theoretical density is 200 MPa or less and a cohesiveness is 0.7 or more.

### CROSS REFERENCE TO PRIOR APPLICATIONS

This application is a U.S. National Phase application under 35 U.S.C. §371 of International Application No. PCT/EP2009/060194, filed on Aug. 6, 2009 and which claims benefit to German Patent Application No. 10 2008 039 668.0, filed on Aug. 26, 2008. The International Application was published in German on Mar. 11, 2010 as WO 2010/026016 A2 under PCT Article 21(2).

### FIELD

The present invention provides a valve metal oxide formulation having organic excipients, wherein the molding pressure necessary for achieving a green density of at least 50% of the theoretic density is 200 MPa or higher, and the force required for the destruction of the blank is 10 MPa or higher in the axial and radial direction. The present invention further relates to a method for the production thereof.

### BACKGROUND

Zirconium oxide is used for production of ceramic bodies as so-called partially or fully stabilized zirconium oxide which are in turn used as components. Examples include medical implants, heat insulation layers, pump rotors or mill linings, but also highly stressed and filigreed construction components. These components are conventionally produced from a ceramic powder by various processes of shaping and subsequent sintering at temperatures above 1000° C. Shaping of the zirconium oxide powder can be carried out by various processes familiar to the person skilled in the art, such as injection molding and belt casting, extrusion, slip casting or electrophoretic deposition, but also more simply and less expensively by axial pressing at or close to room temperature (“cold pressing,” in contrast to hot pressing where axial compaction takes place at high temperatures). A special form of cold pressing is isostatic pressing, in which the powder is filled into a flexible container, which is closed, and compaction is effected by means of a liquid as a pressure transmission medium at pressures of between 300 and 2,200 bar. This shaping is used in particular for large components. In this case, the compact or sintered body is machined in order to bring out the contour of the component.

Since machining of sintered ceramic bodies is expansive due to their high hardness, it is desirable to perform the majority of the mechanical machining in advance by machining the compact by grinding, drilling, milling or machining (“green machining”). A part is thereby produced which is larger in the three spatial dimensions by the expected sintering shrinkage. This is then sintered to the final contour, and subsequently, if at all, subjected to only minor hard machining in order to adhere to the specified dimensions. However, the compact is preferably produced in a way that neither green nor hard machining is necessary (“net shape”). This requires on the one hand a very accurate production of the pressing mold which takes into account the shrinkage of the compact during sintering, and also a sufficiently high internal cohesion (“cohesiveness”) of the compact, which must be ejected from the mold after the pressure is released. A too low cohesiveness leads to fractures on the compact on ejection from the pressing molds and therefore to rejects. A prerequisite for the net shape technology by means of axial pressing already established in powder metallurgy is thus a high cohesiveness, which can, for example, be measured with an apparatus from KZK Powder Tech Corp., USA. From experience in practice, a cohesiveness of at least 0.7, for example, 0.8 or more, for example, 1 or higher, is required for net shape technology. As the cohesiveness increases, the risk of fractures on ejection decreases, and the reject rate is lowered.

The pressed parts are sintered via a suitable temperature program over time, the conventional contents of organic auxiliary substances thereby decomposing and being driven out in the form of gases. The auxiliary substances have diverse tasks, for example, they act as lubricants to make possible the plastic passing of ceramic particles against each other, which are brittle-hard per se, which is necessary during the compaction by pressing. Further organic auxiliary substances act as binders to impart mechanical stability to the compact (“green strength”). Examples of pressing or lubricating auxiliary substances are paraffin, ester or acid amide waxes, and examples of binders are polyethylene glycols, polyvinyl alcohols or polyacrylates. The functional group thereof can also be esterified or alkylated, and copolymers are often used. In the case of very brittle binders, a liquid plasticizer is employed, for example glycol, glycerol or a low molecular weight polyethylene glycol, in order to render the binder auxiliary substance plastically deformable. This list is not exhaustive. Inorganic powders with organic auxiliary substances are formulations.

Zirconium oxide powders which have specific surface areas so high that a sufficient driving force for sintering without pressure exists, serve as the starting material for isostatic or axial pressing. Values of between 3 and 50 m²/g are conventional.

“Stabilizing” in connection with zirconium oxide is understood to mean that other metal oxides which, as pure oxides having a different metal:oxygen ratio to ZrO₂, are dissolved in the zirconium oxide lattice. Y₂O₃, MgO, CaO and further oxides from the group of oxides of the rare earths and combinations of two or more of the abovementioned oxides are conventional. The partial stabilizing has the effect of shifting the phase transformation temperature from tetragonal to monoclinic. Since phase transformations of ZrO₂ are associated with changes in volume which would lead to destruction of the ceramic body, industrially manufactured ceramic bodies are chiefly produced from partially or fully stabilized zirconium oxides, conversion of which to the monoclinic lattice type is frozen at room temperature. Other oxides which form crystalline or vitreous foreign phases, such as e.g. Al₂O₃, or silicates can also be present.

The prevailing teaching has developed from the prior art that for production of ceramic bodies, a partially or fully stabilized zirconium oxide powder should have a monoclinic phase content which is as low as possible, since it is feared that a high monoclinic phase content is an indication of a poor distribution of the stabilizing oxide in the zirconium oxide lattice, which leads to diffusion transportation, and therefore to stresses during sintering, which in turn reduces the strength of the sintered body. Strength is conventionally determined by bending fracture testing on sintered and ground rods in accordance with ISO 843 (4-point flexural strength) or JIS R 1601 (3-point flexural strength).

This teaching has led to production processes for the partially stabilized zirconium oxide powders being aimed at having a monoclinic phase content which is as low as possible. In a zirconium oxide with 3 mol % of Y₂O₃, values of between 5 and 15 vol. % of monoclinic phase, determined by x-ray diffraction, are conventional. Because of the low monoclinic content, conventional production processes for partially stabilized zirconium oxide powders require high temperatures and long holding times to ensure complete distribution of the Y, which is very energy-consuming. Alternatives to this are processes which require no diffusive transportation of Y, such as hydrolysis of Zr/Y mixed chlorides in spray reactors in the gas phase or coprecipitation of Zr salts and Y salts in an aqueous medium. Gas phase hydrolysis requires handling of hazardous, volatile chlorides, and the coprecipitation process generates waste water and a neutral salt, for example sodium chloride or sulfate. Sodium and sulfate must be washed out of the precipitated product thoroughly and with great effort.

Formulation with organic auxiliary substances takes place after the preparation of the zirconium oxide powders by means of the processes described above. If cold isostatic or axial pressing is envisaged as the intended use and the powder is thus required in the dry state for indirect shaping, the zirconium oxide powder is conventionally dispersed in a liquid, the auxiliary substances required are dissolved or dispersed therein. If appropriate, the suspension is then also subjected to grinding by means of a comminuting apparatus. It is then dried to a formulation by means of spray or fluidized bed drying. Agglomerates having dimensions in the range of from 50 to 1,000 μm are formed thereby. Agglomeration is not absolutely necessary for cold isostatic pressing, and the formulation can also be prepared by a procedure in which the zirconium oxide is wetted with a liquid which contains the required auxiliary substances in a dissolved or dispersed form and the moist powder is dried, for example, in a tumble or paddle dryer. In all cases, the organic auxiliary substances for the most part remain after the drying if unintentional evaporation losses do not occur. Formulated zirconium oxide powders often still contain organic auxiliary substances which facilitate the preparation of the dispersion, such as liquefiers, defoamers, surfactants or reagents for adjustment of the pH.

The liquid used for preparation of the dispersion can be either water, alcohols, hydrocarbons or a ketone or mixtures thereof. Although the use of organic liquids is the industrial standard, it has some disadvantages. These are, for example, easy combustibility, explosiveness of the vapors in a mixture with air and adverse effects on the health of employees exposed to them. Water is also possible as the liquid, but difficulties arise here since the granules obtained are very hard as a result of strong interactions of the powder particles with one another (this phenomenon is used, for example, in the production of pottery, where it imparts stability to the bodies after drying). As a result of the hardness and strength of the granules, fracture rather than plastic deformation thereof occurs during pressing, or undestroyed granules remain. As a consequence, pressing defects are found, which in turn manifest themselves in pores in the sintered body. These in turn lower the strength, which is highly undesirable. Powder formulations for ceramics of zirconium oxides have therefore hitherto been prepared by drying from organic liquids as the dispersing liquid.

The flexural strength of sintered ceramic bodies, which is an important quality criterion, depends on several factors. The most important influencing parameters are structural defects, such as are represented by pores or inclusions. A high sintered density and the absence of foreign phases, inclusions and macropores are therefore prerequisites. A high sintered density is only achieved, however, if the driving force of the sintering is high enough. This is achieved by the specific surface area of the zirconium oxide powder, or by the primary particle size thereof, which can be determined by optical means. A further prerequisite is a high compact density. An isotropic compact density after the pressing is furthermore necessary, since compact defects or regions of low compact density generate macropores, distortion due to sintering or stresses in the ceramic body. A strength of at least 800 MPa, for example, greater than 900 MP in accordance with ISO 843 is targeted so that the components are universally usable.

A further prerequisite for achieving a high sintered density (as close as possible to the theoretical density) is a sufficiently high compact density. In the case of sintering without pressure, a compact density of about 50% of the theoretical density or higher, is generally necessary. If it is below this compact density, residual porosity of the sintered body increasingly occurs. The pressing pressure available is usually limited by the pressing force available, which is a particular disadvantage for flat parts. The pressing force necessary to achieve 50% of the theoretical density is therefore particularly important. Furthermore, wear of pressing tools correspondingly increases with the pressing pressure applied, so that practical considerations set forth a limit.

The zirconium oxide powders known hitherto as formulations with organic auxiliary substances can indeed be produced to give sintered bodies of sufficient strength, but not in net shape technology by means of axial pressing. A large proportion of hard machining, which must be carried out in an involved manner with expensive diamond or cBN tools, is therefore currently necessarily. As an alternative thereto, machining can be carried out in the green state, which requires, however, a corresponding green strength and leads to powder losses which can be recycled only with difficulty. There is therefore a great interest in those zirconium oxides which are formulated with organic auxiliary substances in a way that they can be processed by means of axial pressing in net shape technology with little waste and without excessive hard machining to provide sintered parts without compromising the properties of the sintered bodies. A sufficiently high cohesiveness is therefore necessary. This depends almost entirely on the organic auxiliary substances used, since in contrast to metal powders, ceramic particles have neither ductile nor cold weldability properties during compaction, and the cohesiveness must be established entirely via the organic auxiliary substances.

Various methods exist for determining cohesiveness. Complete characterization of the compaction properties and the properties of the compact is possible by means of the KZK powder tester of KZK Powder Tech Corp. The following are, for example, evaluated:

The bulk and tap density, the ratio of which (Hausner ratio) is a measure of the compactability;

The pressing pressure necessary for a given compact density (for a given compact density, this is a measure of the deformation resistance and should be as low as possible, if possible lower than 200 MPa at 50% of the theoretical density);

The sliding coefficient (a measure of the friction of the powder on the wall of the pressing tool during the compaction operation, the value should be as close to one as possible, since otherwise wear occurs on the pressing molds);

The elastic relaxation after ejection of the compact (a measure of the internal stresses, this should be as low as possible so that the contour of the compact can be controlled);

The cohesiveness (a measure of the internal cohesion of the compact on ejection from the mold, the value). The cohesiveness is calculated from the ratio of the green strength and the ejection force required, and the value should therefore be at least close to one, but at least above 0.8. Damage to the compact on ejection is otherwise expected; and

The force in the axial and radial direction required to destroy the compact (both are a measure of the green strength, and the values should be as high as possible and should be above 10 MPa).

The actual green density measured on the ejected compact may be lower than the predetermined green density as a result of the elastic relaxation.

A further measure of the compactability is the so-called Hausner ratio, which is the ratio between the tap and bulk density. The higher the Hausner ratio above the value of one, the lower the deformation resistance of a powder. A further measure of the compactability is the pressing pressure necessary to achieve a certain compact density. This is relevant for industrial uses since it determines the pressing force necessary for large parts. If the compact density is too low, for example, because no sufficiently strong press is available for axial pressing, an adequate sintered density is not achieved. The strength of the ceramic part is weakened since pores then remain.

### SUMMARY

An aspect of the present invention is to provide an agglomerated zirconium oxide in a formulation with organic auxiliary substances which at a given pressing pressure has a cohesiveness sufficient for net shape technology of at least 0.7, and which can be pressed to dense compacts under low pressing pressures, and have dense sintered specimens with an adequate strength.

In an embodiment, the present invention provides a formulation of at least one of a partially and a fully stabilized zirconium oxide powder which includes at least one organic auxiliary substance, wherein a pressing pressure so as to obtain a green density of at least 50% of the theoretical density is 200 MPa or less and the cohesiveness is 0.7 or more.

### DETAILED DESCRIPTION

In an embodiment, the present invention provides an agglomerated zirconium oxide formulation with organic auxiliary substances, which can be compacted under pressing pressures of 200 MPa or less to give compacts with at least 50% of the theoretical density and has a force in the axial and radial direction necessary to destroy the compact of 10 MPa or more and an adequate strength in the sintered part.

It has now surprisingly been found that a ceramic body produced via pressing and sintering and with an adequate flexural strength can be produced even from zirconium oxide powder with a monoclinic phase content of significantly above 30% even when using water as the dispersing liquid, if at the same time the organic formulation is modified in a way that one or more carboxylic acids are used in addition to the binder. Although the action of the carboxylic acids is unclear, these evidently facilitate the compaction operation and increase the cohesiveness in a way that net shape technology can be used.

In an embodiment of the present invention, the zirconium oxide in the formulation is stabilized with 2 mol % to 12 mol % of yttrium oxide, for example, with 3 mol % to 8 mol % or with 3 mol % to 6 mol %.

In an embodiment of the present invention, the zirconium oxide has a monoclinic phase content of up to 30%, for example, of up to 40%, or up to 50% and more. However, the monoclinic phase content should at most be 90%.

The pressing pressure under which 50% of the theoretical density is achieved can, for example, be less than 200 MPa, less than 150 MPa, less than 100 MPa, less than 90 MPa, or even less than 80 MPa. This value can even be less than 70 MPa.

The cohesiveness can, for example, be greater than or equal to 0.7, for example, greater than 0.8, or 1 or higher.

The formulation according to the present invention contains organic auxiliary substances.

The formulation can contain at least one carboxylic acid. This carboxylic acid can, for example, be in an amount of from 0.1 to 5 wt. %, for example, in an amount of from 0.25 to 2.4 wt. %, or from 0.5 to 1 wt. %. In general, a use of 0.5 wt. % or more of the carboxylic acid provides good results. The carboxylic acid can, for example, have a melting point of from 35° C. to 100° C.

In an embodiment, the present invention also provides a process for the preparation of a zirconium oxide formulation, wherein at least one carboxylic acid and at least one binder is added to the zirconium oxide in the presence of a solvent.

The zirconium oxide can, for example, be present as a dispersion or as a suspension in the solvent.

This can, for example, be effected with water as the solvent in the preparation of the suspension or dispersion, as an intermediate product into which the carboxylic acid and the binder are introduced.

The carboxylic acid and the binder can, for example, be added jointly, i.e., together as a solution, dispersion or suspension in a solvent, or spatially separately from one another but simultaneously. The can also, for example, be added sequentially to the suspension or to the dispersion of the zirconium oxide. The carboxylic acid can also be added in the solid form or in the form of a melt.

In an embodiment of the present invention, first the carboxylic acid and then the binder is added.

The present invention thus also relates to a process for the preparation of a zirconium oxide formulation with the steps:

provision of a zirconium oxide suspension or dispersion;

provision of a carboxylic acid in the form of a solution, suspension or dispersion;

provision of a binder in the form of a solution, suspension or dispersion;

addition of the carboxylic acid to the zirconium oxide suspension or dispersion to obtain a first suspension or dispersion as an intermediate product;

addition of the binder to the first suspension or dispersion to obtain a second dispersion;

drying of the second dispersion to obtain granules.

In an embodiment, the present invention provides a process for the preparation of a zirconium oxide formulation with the steps:

provision of a zirconium oxide suspension or dispersion;

provision of a short-chained carboxylic acid in the form of a solution, suspension or dispersion;

provision of a long-chained carboxylic acid in the form of a solution, suspension or dispersion;

provision of a binder in the form of a solution, suspension or dispersion;

addition of the short-chained carboxylic acid to the zirconium oxide suspension or dispersion to obtain a first suspension or dispersion as an intermediate product;

addition of the long-chained carboxylic acid to the zirconium oxide suspension or dispersion to obtain a second suspension or dispersion as an intermediate product;

addition of the binder to the second suspension or dispersion to obtain a third dispersion;

drying of the third dispersion to obtain granules.

The addition of the carboxylic acid can, for example, take place at a basic pH and can, for example, be carried out at a pH of from 8 to 12, for example, from 8.4 to 11, or at a pH of from 9 to 10. The addition of the binder is likewise carried out at a basic pH, for example, at a pH of from 8 to 12, or from 8.4 to 11, or from 9 to 10.

The addition both of the binder and of the carboxylic acid can, for example, be carried out at a temperature of less than 60° C., for example, at less than 50° C., or at less than 35° C. The temperature is ideally room temperature, which is, for example, from about 15° C. to about 28° C., or from 18° C. to 23° C.

The drying can in principle be carried out by any known process, such as, for example, through spray drying or related processes. The carboxylic acids employed can, for example, remain in the end product, the granules.

In an embodiment, the present invention provides a process for the preparation of a zirconium oxide formulation with the steps:

provision of a zirconium oxide suspension or dispersion;

provision of a short-chained carboxylic acid in the form of a solution, suspension or dispersion;

provision of a long-chained carboxylic acid in the form of a solution, suspension or dispersion;

provision of a binder in the form of a solution, suspension or dispersion;

addition of the short-chained carboxylic acid to the zirconium oxide suspension or dispersion to obtain a first suspension or dispersion as an intermediate product;

addition of the long-chained carboxylic acid to the zirconium oxide suspension or dispersion to obtain a second suspension or dispersion as an intermediate product;

addition of the binder to the second suspension or dispersion to obtain a third dispersion;

drying of the third dispersion to obtain granules, the addition of the long-chained carboxylic acid, the short-chained carboxylic acid and the binder in each case being carried out at temperatures of less than 50° C. and at a pH of from 8 to 12.

Carboxylic acids are understood as meaning those organic substances which contain at least one or more carboxyl groups or acquire these by reaction in the suspension. According to the present invention, at least one carboxyl group is not esterified but is present in protonated form. The carboxylic acid can also be employed as a salt, such as, for example, as water-soluble salts of the alkali metals or alkaline earth metals, of zirconium or yttrium or ammonium salts. Corresponding acid chlorides can also be used, since they hydrolyze in aqueous media to provide carboxylic acids, and are therefore referred to as carboxylic acids in the context of the present invention.

The formulation according to the present invention can, for example, contain carboxylic acids which are present in their solid form at room temperature since they have a low vapor pressure and it is therefore ensured that they remain in the dried formulation.

A relatively small content of one or more short-chained carboxylic acid(s) which is liquid at room temperature can also be used, for example, acetic acid or salts thereof, if necessary to control pH. In the case of short-chained carboxylic acids, the addition of the abovementioned carboxylic acid salts can, for example, be used to reduce volatility.

In an embodiment of the present invention, a carboxylic acid of wax-like consistency is used with a the melting point or melting range of between 35 and 100° C.

The carboxylic acids can, for example, be unbranched carboxylic acids, however, they can also be branched or straight-chained.

The carboxylic acid can also contain ether and/or hydroxyl groups. At least one carboxyl group can, for example be terminal.

The carboxylic acid can also be short-chained and nevertheless solid at room temperature, but in return have a higher acidity, for example, oxalic acid, tartaric acid or citric acid.

The carboxylic acids used can in general be mono- di- tri- or polycarboxylic acids, which contain 1 to 30 carbon atoms and, for example, have a melting point or melting range of between 35 and 100° C. On the one hand, short-chained carboxylic acids can be used, these being understood according to the present invention to include carboxylic acids having 1 to 8 carbon atoms. These have a melting point or a melting range of, for example, from 35 to 100° C., and are present either as the free carboxylic acid or as an alkali metal or ammonium salt. Mixtures of these carboxylic acids with one another or alkali metal and ammonium salts thereof can also be used.

A long-chained carboxylic acid can likewise be used, these being understood according to the present invention to include carboxylic acids having 10 to 30 carbon atoms, for example, 10 to 23 carbon atoms.

These can, for example, be saturated or unsaturated aliphatic carboxylic acids. The carbon chain can, for example, be linear, branched or cyclic. The carbon chain can also contain ether groups.

The carboxylic acids can, for example, be unsubstituted or substituted Substituents can, for example, include one or more nitro groups, amino groups, F, Cl, Br, I, or hydroxyl groups, or can contain ether or hydroxyl groups, such as hydroxypropionic acid or citric acid.

The carboxylic acids can, for example, be mono- or polyunsaturated.

The long-chained carboxylic acids can, for example, be saturated fatty acids with a melting point range or melting range of between 35 and 100° C., such as, for example, montanic acid, palmitic acid, stearic acid, mixtures thereof with one another or other carboxylic acids or mixtures of alkali metal or ammonium salts thereof with one another or other carboxylic acids of alkali metal or ammonium salts thereof.

Short-chained carboxylic acids according to the present invention include, for example acetic acid, oxalic acid, glycolic acid, propionic acid, methoxyacetic acid, lactic acid, malonic acid, butyric acid, 2-hydroxybutyric acid, 3-hydroxybutyric acid, butanedioic acid, ethoxyacetic acid, 2,2′-oxydiacetic acid, methoxypropionic acid, succinic acid, ascorbic acid, methylmalonic acid, 2-hydroxysuccinic acid, 2,3-dihydroxysuccinic acid (tartaric acid), dihydroxyfumaric acid, valeric acid, trimethylacetic acid, 2-methylbutanoic acid, isovaleric acid, (Z)-2-methyl-2-butenoic acid (angelica acid), glutaric acid, 3,6-dioxaoctanedioic acid, 2-(2-methoxyethoxy)acetic acid, trans-2,3-dimethylacrylic acid (tiglic acid), glutamic acid, caproic acid, 3-methylvaleric acid, cis-propene-1,2,3-tricarboxylic acid (cis-aconitic acid), 2,2-dimethylbutanedioic acid, 2,3-dimethylbutanedioic acid, 2-methylglutaric acid, 3-methylglutaric acid, citric acid, 2,3,4,5-tetrahydroxyhexanoic acid (mucic acid), oenanthic acid, 2-propylpentanoic acid, butylmalonic acid, diethylmalonic acid, tetrahydroxyheptanoic acid (quinic acid), 2-[2-(methoxyethoxy)ethoxy]acetic acid, acelaic acid, (3R,4S,5R)-3,4,5-trihydroxy-1-cyclohexenecarboxylic acid (shikimic acid), caprylic acid, pelargonic acid, nonanedioic acid (azelaic acid), sebacic acid, salts thereof with alkali metal salts or ammonium salts, acid chlorides or mixtures thereof.

Long-chained carboxylic acids, that is to say carboxylic acids having 10 to 30 carbon atoms, include, for example, generally fatty acids, or alkali metal or ammonium salts thereof. The long-chained carboxylic acids can, for example, be solid at room temperature. Saturated and mono- or polyunsaturated fatty acids can also be employed. Suitable and broadly suitable long-chained carboxylic acids according to the present invention include saturated fatty acids, such as lauric acid, myristic acid, palmitic acid, margaric acid, stearic acid, arachic acid, behenic acid, lignoceric acid, cerotic acid, montanic acid, melissic acid, monounsaturated fatty acids, such as undecylenic acid, myristoleic acid, palmitoleic acid, petroselic acid, oleic acid, elaidic acid, vaccenic acid, gadoleic acid, icosenic acid, cetoleic acid, erucic acid, nervonic acid, polyunsaturated fatty acids, such as, for example, linoleic acid, alpha-linolenic acid, gamma-linolenic acid, calendic acid, punicic acid, alpha-eleostearic acid, arachidonic acid, timnodonic acid, clupanodonic acid, cervonic acid, vernolic acid, ricinoleic acid and mixtures thereof and mixtures of alkali metal and ammonium salts thereof.

The carboxylic acid can, for example, be added as an aqueous dispersion. In such a case, it can also additionally contain emulsifiers, such as, for example, fatty acid glycerol esters.

The carboxylic acid can also at least partly be used as a solution if it is partly or completely neutralized, with for example, ammonia.

The carboxylic acid can also be a mixture of several different carboxylic acids, in which case reference is made to herein to a carboxylic acid formulation.

A solution or a dispersion of one or more carboxylic acids, both optionally also partly neutralized by ammonia or short-chained amines, is called a carboxylic acid formulation. This can, for example, also be a mixture of a solution and a dispersion.

In an embodiment of the present invention, at least one of the aforementioned short-chained and one long-chained carboxylic acid are used as a carboxylic acid formulation, as a solution, a dispersion or in each case in partly dissolved and dispersed form.

The long-chained and the short-chained carboxylic acid can be added together as a formulation, simultaneously or sequentially. Since a simple reactor can be used, addition can, for example, be sequential, in which case the short-chained carboxylic acid can, for example, be added first.

Table 1 shows suitable combinations of short-chained carboxylic acids with long-chained carboxylic acids and formulations thereof. Individual combinations are designated by the number of the table, followed by the number of the particular combination in Table 1. For example, combination 2.005 means the combination of the carboxylic acids as in Table 1, position no. 5 with the form shown in Table 2 in which the carboxylic acid is present.

| | | Long-chained |
|---|---|---|
| Number | Short-chained carboxylic acid | carboxylic acid |
| 1.001 | oxalic acid | lauric acid |
| 1.002 | oxalic acid | myristic acid |
| 1.003 | oxalic acid | palmitic acid |
| 1.004 | oxalic acid | margaric acid |
| 1.005 | oxalic acid | stearic acid |
| 1.006 | oxalic acid | arachic acid |
| 1.007 | oxalic acid | behenic acid |
| 1.008 | oxalic acid | lignoceric acid |
| 1.009 | oxalic acid | montanic acid |
| 1.010 | oxalic acid | undecylenic acid |
| 1.011 | oxalic acid | myristoleic acid |
| 1.012 | oxalic acid | palmitoleic acid |
| 1.013 | oxalic acid | petroselic acid |
| 1.014 | oxalic acid | oleic acid |
| 1.015 | oxalic acid | elaidic acid |
| 1.016 | oxalic acid | icosenic acid |
| 1.017 | oxalic acid | cetoleic acid |
| 1.018 | oxalic acid | erucic acid |
| 1.019 | oxalic acid | nervonic acid |
| 1.020 | oxalic acid | linoleic acid |
| 1.021 | oxalic acid | alpha-linolenic acid |
| 1.022 | oxalic acid | calendic acid |
| 1.023 | oxalic acid | punicic acid |
| 1.024 | oxalic acid | alpha-eleostearic acid |
| 1.025 | oxalic acid | arachidonic acid |
| 1.026 | oxalic acid | timnodonic acid |
| 1.027 | oxalic acid | clupanodonic acid |
| 1.028 | oxalic acid | ricinoleic acid |
| 1.029 | glycolic acid | lauric acid |
| 1.030 | glycolic acid | myristic acid |
| 1.031 | glycolic acid | palmitic acid |
| 1.032 | glycolic acid | margaric acid |
| 1.033 | glycolic acid | stearic acid |
| 1.034 | glycolic acid | arachic acid |
| 1.035 | glycolic acid | behenic acid |
| 1.036 | glycolic acid | lignoceric acid |
| 1.037 | glycolic acid | montanic acid |
| 1.038 | glycolic acid | undecylenic acid |
| 1.039 | glycolic acid | myristoleic acid |
| 1.040 | glycolic acid | palmitoleic acid |
| 1.041 | glycolic acid | petroselic acid |
| 1.042 | glycolic acid | oleic acid |
| 1.043 | glycolic acid | elaidic acid |
| 1.044 | glycolic acid | icosenic acid |
| 1.045 | glycolic acid | cetoleic acid |
| 1.046 | glycolic acid | erucic acid |
| 1.047 | glycolic acid | nervonic acid |
| 1.048 | glycolic acid | linoleic acid |
| 1.049 | glycolic acid | alpha-linolenic acid |
| 1.050 | glycolic acid | calendic acid |
| 1.051 | glycolic acid | punicic acid |
| 1.052 | glycolic acid | alpha-eleostearic acid |
| 1.053 | glycolic acid | arachidonic acid |
| 1.054 | glycolic acid | timnodonic acid |
| 1.055 | glycolic acid | clupanodonic acid |
| 1.056 | glycolic acid | ricinoleic acid |
| 1.057 | methoxyacetic acid | lauric acid |
| 1.058 | methoxyacetic acid | myristic acid |
| 1.059 | methoxyacetic acid | palmitic acid |
| 1.060 | methoxyacetic acid | margaric acid |
| 1.061 | methoxyacetic acid | stearic acid |
| 1.062 | methoxyacetic acid | arachic acid |
| 1.063 | methoxyacetic acid | behenic acid |
| 1.064 | methoxyacetic acid | lignoceric acid |
| 1.065 | methoxyacetic acid | montanic acid |
| 1.066 | methoxyacetic acid | undecylenic acid |
| 1.067 | methoxyacetic acid | myristoleic acid |
| 1.068 | methoxyacetic acid | palmitoleic acid |
| 1.069 | methoxyacetic acid | petroselic acid |
| 1.070 | methoxyacetic acid | oleic acid |
| 1.071 | methoxyacetic acid | elaidic acid |
| 1.072 | methoxyacetic acid | icosenic acid |
| 1.073 | methoxyacetic acid | cetoleic acid |
| 1.074 | methoxyacetic acid | erucic acid |
| 1.075 | methoxyacetic acid | nervonic acid |
| 1.076 | methoxyacetic acid | linoleic acid |
| 1.077 | methoxyacetic acid | alpha-linolenic acid |
| 1.078 | methoxyacetic acid | calendic acid |
| 1.079 | methoxyacetic acid | punicic acid |
| 1.080 | methoxyacetic acid | alpha-eleostearic acid |
| 1.081 | methoxyacetic acid | arachidonic acid |
| 1.082 | methoxyacetic acid | timnodonic acid |
| 1.083 | methoxyacetic acid | clupanodonic acid |
| 1.084 | methoxyacetic acid | ricinoleic acid |
| 1.085 | lactic acid | lauric acid |
| 1.086 | lactic acid | myristic acid |
| 1.087 | lactic acid | palmitic acid |
| 1.088 | lactic acid | margaric acid |
| 1.089 | lactic acid | stearic acid |
| 1.090 | lactic acid | arachic acid |
| 1.091 | lactic acid | behenic acid |
| 1.092 | lactic acid | lignoceric acid |
| 1.093 | lactic acid | montanic acid |
| 1.094 | lactic acid | undecylenic acid |
| 1.095 | lactic acid | myristoleic acid |
| 1.096 | lactic acid | palmitoleic acid |
| 1.097 | lactic acid | petroselic acid |
| 1.098 | lactic acid | oleic acid |
| 1.099 | lactic acid | elaidic acid |
| 1.100 | lactic acid | icosenic acid |
| 1.101 | lactic acid | cetoleic acid |
| 1.102 | lactic acid | erucic acid |
| 1.103 | lactic acid | nervonic acid |
| 1.104 | lactic acid | linoleic acid |
| 1.105 | lactic acid | alpha-linolenic acid |
| 1.106 | lactic acid | calendic acid |
| 1.107 | lactic acid | punicic acid |
| 1.108 | lactic acid | alpha-eleostearic acid |
| 1.109 | lactic acid | arachidonic acid |
| 1.110 | lactic acid | timnodonic acid |
| 1.111 | lactic acid | clupanodonic acid |
| 1.112 | lactic acid | ricinoleic acid |
| 1.113 | malonic acid | lauric acid |
| 1.114 | malonic acid | myristic acid |
| 1.115 | malonic acid | palmitic acid |
| 1.116 | malonic acid | margaric acid |
| 1.117 | malonic acid | stearic acid |
| 1.118 | malonic acid | arachic acid |
| 1.119 | malonic acid | behenic acid |
| 1.120 | malonic acid | lignoceric acid |
| 1.121 | malonic acid | montanic acid |
| 1.122 | malonic acid | undecylenic acid |
| 1.123 | malonic acid | myristoleic acid |
| 1.124 | malonic acid | palmitoleic acid |
| 1.125 | malonic acid | petroselic acid |
| 1.126 | malonic acid | oleic acid |
| 1.127 | malonic acid | elaidic acid |
| 1.128 | malonic acid | icosenic acid |
| 1.129 | malonic acid | cetoleic acid |
| 1.130 | malonic acid | erucic acid |
| 1.131 | malonic acid | nervonic acid |
| 1.132 | malonic acid | linoleic acid |
| 1.133 | malonic acid | alpha-linolenic acid |
| 1.134 | malonic acid | calendic acid |
| 1.135 | malonic acid | punicic acid |
| 1.136 | malonic acid | alpha-eleostearic acid |
| 1.137 | malonic acid | arachidonic acid |
| 1.138 | malonic acid | timnodonic acid |
| 1.139 | malonic acid | clupanodonic acid |
| 1.140 | malonic acid | ricinoleic acid |
| 1.141 | ethoxyacetic acid | lauric acid |
| 1.142 | ethoxyacetic acid | myristic acid |
| 1.143 | ethoxyacetic acid | palmitic acid |
| 1.144 | ethoxyacetic acid | margaric acid |
| 1.145 | ethoxyacetic acid | stearic acid |
| 1.146 | ethoxyacetic acid | arachic acid |
| 1.147 | ethoxyacetic acid | behenic acid |
| 1.148 | ethoxyacetic acid | lignoceric acid |
| 1.149 | ethoxyacetic acid | montanic acid |
| 1.150 | ethoxyacetic acid | undecylenic acid |
| 1.151 | ethoxyacetic acid | myristoleic acid |
| 1.152 | ethoxyacetic acid | palmitoleic acid |
| 1.153 | ethoxyacetic acid | petroselic acid |
| 1.154 | ethoxyacetic acid | oleic acid |
| 1.155 | ethoxyacetic acid | elaidic acid |
| 1.156 | ethoxyacetic acid | icosenic acid |
| 1.157 | ethoxyacetic acid | cetoleic acid |
| 1.158 | ethoxyacetic acid | erucic acid |
| 1.159 | ethoxyacetic acid | nervonic acid |
| 1.160 | ethoxyacetic acid | linoleic acid |
| 1.161 | ethoxyacetic acid | alpha-linolenic acid |
| 1.162 | ethoxyacetic acid | calendic acid |
| 1.163 | ethoxyacetic acid | punicic acid |
| 1.164 | ethoxyacetic acid | alpha-eleostearic acid |
| 1.165 | ethoxyacetic acid | arachidonic acid |
| 1.166 | ethoxyacetic acid | timnodonic acid |
| 1.167 | ethoxyacetic acid | clupanodonic acid |
| 1.168 | ethoxyacetic acid | ricinoleic acid |
| 1.169 | 2,2′-oxydiacetic acid | lauric acid |
| 1.170 | 2,2′-oxydiacetic acid | myristic acid |
| 1.171 | 2,2′-oxydiacetic acid | palmitic acid |
| 1.172 | 2,2′-oxydiacetic acid | margaric acid |
| 1.173 | 2,2′-oxydiacetic acid | stearic acid |
| 1.174 | 2,2′-oxydiacetic acid | arachic acid |
| 1.175 | 2,2′-oxydiacetic acid | behenic acid |
| 1.176 | 2,2′-oxydiacetic acid | lignoceric acid |
| 1.177 | 2,2′-oxydiacetic acid | montanic acid |
| 1.178 | 2,2′-oxydiacetic acid | undecylenic acid |
| 1.179 | 2,2′-oxydiacetic acid | myristoleic acid |
| 1.180 | 2,2′-oxydiacetic acid | palmitoleic acid |
| 1.181 | 2,2′-oxydiacetic acid | petroselic acid |
| 1.182 | 2,2′-oxydiacetic acid | oleic acid |
| 1.183 | 2,2′-oxydiacetic acid | elaidic acid |
| 1.184 | 2,2′-oxydiacetic acid | icosenic acid |
| 1.185 | 2,2′-oxydiacetic acid | cetoleic acid |
| 1.186 | 2,2′-oxydiacetic acid | erucic acid |
| 1.187 | 2,2′-oxydiacetic acid | nervonic acid |
| 1.188 | 2,2′-oxydiacetic acid | linoleic acid |
| 1.189 | 2,2′-oxydiacetic acid | alpha-linolenic acid |
| 1.190 | 2,2′-oxydiacetic acid | calendic acid |
| 1.191 | 2,2′-oxydiacetic acid | punicic acid |
| 1.192 | 2,2′-oxydiacetic acid | alpha-eleostearic acid |
| 1.193 | 2,2′-oxydiacetic acid | arachidonic acid |
| 1.194 | 2,2′-oxydiacetic acid | timnodonic acid |
| 1.195 | 2,2′-oxydiacetic acid | clupanodonic acid |
| 1.196 | 2,2′-oxydiacetic acid | ricinoleic acid |
| 1.197 | succinic acid | lauric acid |
| 1.198 | succinic acid | myristic acid |
| 1.199 | succinic acid | palmitic acid |
| 1.200 | succinic acid | margaric acid |
| 1.201 | succinic acid | stearic acid |
| 1.202 | succinic acid | arachic acid |
| 1.203 | succinic acid | behenic acid |
| 1.204 | succinic acid | lignoceric acid |
| 1.205 | succinic acid | montanic acid |
| 1.206 | succinic acid | undecylenic acid |
| 1.207 | succinic acid | myristoleic acid |
| 1.208 | succinic acid | palmitoleic acid |
| 1.209 | succinic acid | petroselic acid |
| 1.210 | succinic acid | oleic acid |
| 1.211 | succinic acid | elaidic acid |
| 1.212 | succinic acid | icosenic acid |
| 1.213 | succinic acid | cetoleic acid |
| 1.214 | succinic acid | erucic acid |
| 1.215 | succinic acid | nervonic acid |
| 1.216 | succinic acid | linoleic acid |
| 1.217 | succinic acid | alpha-linolenic acid |
| 1.218 | succinic acid | calendic acid |
| 1.219 | succinic acid | punicic acid |
| 1.220 | succinic acid | alpha-eleostearic acid |
| 1.221 | succinic acid | arachidonic acid |
| 1.222 | succinic acid | timnodonic acid |
| 1.223 | succinic acid | clupanodonic acid |
| 1.224 | succinic acid | ricinoleic acid |
| 1.225 | ascorbic acid | lauric acid |
| 1.226 | ascorbic acid | myristic acid |
| 1.227 | ascorbic acid | palmitic acid |
| 1.228 | ascorbic acid | margaric acid |
| 1.229 | ascorbic acid | stearic acid |
| 1.230 | ascorbic acid | arachic acid |
| 1.231 | ascorbic acid | behenic acid |
| 1.232 | ascorbic acid | lignoceric acid |
| 1.233 | ascorbic acid | montanic acid |
| 1.234 | ascorbic acid | undecylenic acid |
| 1.235 | ascorbic acid | myristoleic acid |
| 1.236 | ascorbic acid | palmitoleic acid |
| 1.237 | ascorbic acid | petroselic acid |
| 1.238 | ascorbic acid | oleic acid |
| 1.239 | ascorbic acid | elaidic acid |
| 1.240 | ascorbic acid | icosenic acid |
| 1.241 | ascorbic acid | cetoleic acid |
| 1.242 | ascorbic acid | erucic acid |
| 1.243 | ascorbic acid | nervonic acid |
| 1.244 | ascorbic acid | linoleic acid |
| 1.245 | ascorbic acid | alpha-linolenic acid |
| 1.246 | ascorbic acid | calendic acid |
| 1.247 | ascorbic acid | punicic acid |
| 1.248 | ascorbic acid | alpha-eleostearic acid |
| 1.249 | ascorbic acid | arachidonic acid |
| 1.250 | ascorbic acid | timnodonic acid |
| 1.251 | ascorbic acid | clupanodonic acid |
| 1.252 | ascorbic acid | ricinoleic acid |
| 1.253 | tartaric acid | lauric acid |
| 1.254 | tartaric acid | myristic acid |
| 1.255 | tartaric acid | palmitic acid |
| 1.256 | tartaric acid | margaric acid |
| 1.257 | tartaric acid | stearic acid |
| 1.258 | tartaric acid | arachic acid |
| 1.259 | tartaric acid | behenic acid |
| 1.260 | tartaric acid | lignoceric acid |
| 1.261 | tartaric acid | montanic acid |
| 1.262 | tartaric acid | undecylenic acid |
| 1.263 | tartaric acid | myristoleic acid |
| 1.264 | tartaric acid | palmitoleic acid |
| 1.265 | tartaric acid | petroselic acid |
| 1.266 | tartaric acid | oleic acid |
| 1.267 | tartaric acid | elaidic acid |
| 1.268 | tartaric acid | icosenic acid |
| 1.269 | tartaric acid | cetoleic acid |
| 1.270 | tartaric acid | erucic acid |
| 1.271 | tartaric acid | nervonic acid |
| 1.272 | tartaric acid | linoleic acid |
| 1.273 | tartaric acid | alpha-linolenic acid |
| 1.274 | tartaric acid | calendic acid |
| 1.275 | tartaric acid | punicic acid |
| 1.276 | tartaric acid | alpha-eleostearic acid |
| 1.277 | tartaric acid | arachidonic acid |
| 1.278 | tartaric acid | timnodonic acid |
| 1.279 | tartaric acid | clupanodonic acid |
| 1.280 | tartaric acid | ricinoleic acid |
| 1.281 | dihydroxyfumaric acid | lauric acid |
| 1.282 | dihydroxyfumaric acid | myristic acid |
| 1.283 | dihydroxyfumaric acid | palmitic acid |
| 1.284 | dihydroxyfumaric acid | margaric acid |
| 1.285 | dihydroxyfumaric acid | stearic acid |
| 1.286 | dihydroxyfumaric acid | arachic acid |
| 1.287 | dihydroxyfumaric acid | behenic acid |
| 1.288 | dihydroxyfumaric acid | lignoceric acid |
| 1.289 | dihydroxyfumaric acid | montanic acid |
| 1.290 | dihydroxyfumaric acid | undecylenic acid |
| 1.291 | dihydroxyfumaric acid | myristoleic acid |
| 1.292 | dihydroxyfumaric acid | palmitoleic acid |
| 1.293 | dihydroxyfumaric acid | petroselic acid |
| 1.294 | dihydroxyfumaric acid | oleic acid |
| 1.295 | dihydroxyfumaric acid | elaidic acid |
| 1.296 | dihydroxyfumaric acid | icosenic acid |
| 1.297 | dihydroxyfumaric acid | cetoleic acid |
| 1.298 | dihydroxyfumaric acid | erucic acid |
| 1.299 | dihydroxyfumaric acid | nervonic acid |
| 1.300 | dihydroxyfumaric acid | linoleic acid |
| 1.301 | dihydroxyfumaric acid | alpha-linolenic acid |
| 1.302 | dihydroxyfumaric acid | calendic acid |
| 1.303 | dihydroxyfumaric acid | punicic acid |
| 1.304 | dihydroxyfumaric acid | alpha-eleostearic acid |
| 1.305 | dihydroxyfumaric acid | arachidonic acid |
| 1.306 | dihydroxyfumaric acid | timnodonic acid |
| 1.307 | dihydroxyfumaric acid | clupanodonic acid |
| 1.308 | dihydroxyfumaric acid | ricinoleic acid |
| 1.309 | trimethylacetic acid | lauric acid |
| 1.310 | trimethylacetic acid | myristic acid |
| 1.311 | trimethylacetic acid | palmitic acid |
| 1.312 | trimethylacetic acid | margaric acid |
| 1.313 | trimethylacetic acid | stearic acid |
| 1.314 | trimethylacetic acid | arachic acid |
| 1.315 | trimethylacetic acid | behenic acid |
| 1.316 | trimethylacetic acid | lignoceric acid |
| 1.317 | trimethylacetic acid | montanic acid |
| 1.318 | trimethylacetic acid | undecylenic acid |
| 1.319 | trimethylacetic acid | myristoleic acid |
| 1.320 | trimethylacetic acid | palmitoleic acid |
| 1.321 | trimethylacetic acid | petroselic acid |
| 1.322 | trimethylacetic acid | oleic acid |
| 1.323 | trimethylacetic acid | elaidic acid |
| 1.324 | trimethylacetic acid | icosenic acid |
| 1.325 | trimethylacetic acid | cetoleic acid |
| 1.326 | trimethylacetic acid | erucic acid |
| 1.327 | trimethylacetic acid | nervonic acid |
| 1.328 | trimethylacetic acid | linoleic acid |
| 1.329 | trimethylacetic acid | alpha-linolenic acid |
| 1.330 | trimethylacetic acid | calendic acid |
| 1.331 | trimethylacetic acid | punicic acid |
| 1.332 | trimethylacetic acid | alpha-eleostearic acid |
| 1.333 | trimethylacetic acid | arachidonic acid |
| 1.334 | trimethylacetic acid | timnodonic acid |
| 1.335 | trimethylacetic acid | clupanodonic acid |
| 1.336 | trimethylacetic acid | ricinoleic acid |
| 1.337 | glutaric acid | lauric acid |
| 1.338 | glutaric acid | myristic acid |
| 1.339 | glutaric acid | palmitic acid |
| 1.340 | glutaric acid | margaric acid |
| 1.341 | glutaric acid | stearic acid |
| 1.342 | glutaric acid | arachic acid |
| 1.343 | glutaric acid | behenic acid |
| 1.344 | glutaric acid | lignoceric acid |
| 1.345 | glutaric acid | montanic acid |
| 1.346 | glutaric acid | undecylenic acid |
| 1.347 | glutaric acid | myristoleic acid |
| 1.348 | glutaric acid | palmitoleic acid |
| 1.349 | glutaric acid | petroselic acid |
| 1.350 | glutaric acid | oleic acid |
| 1.351 | glutaric acid | elaidic acid |
| 1.352 | glutaric acid | icosenic acid |
| 1.353 | glutaric acid | cetoleic acid |
| 1.354 | glutaric acid | erucic acid |
| 1.355 | glutaric acid | nervonic acid |
| 1.356 | glutaric acid | linoleic acid |
| 1.357 | glutaric acid | alpha-linolenic acid |
| 1.358 | glutaric acid | calendic acid |
| 1.359 | glutaric acid | punicic acid |
| 1.360 | glutaric acid | alpha-eleostearic acid |
| 1.361 | glutaric acid | arachidonic acid |
| 1.362 | glutaric acid | timnodonic acid |
| 1.363 | glutaric acid | clupanodonic acid |
| 1.364 | glutaric acid | ricinoleic acid |
| 1.365 | 3,6-dioxaoctanedioic acid | lauric acid |
| 1.366 | 3,6-dioxaoctanedioic acid | myristic acid |
| 1.367 | 3,6-dioxaoctanedioic acid | palmitic acid |
| 1.368 | 3,6-dioxaoctanedioic acid | margaric acid |
| 1.369 | 3,6-dioxaoctanedioic acid | stearic acid |
| 1.370 | 3,6-dioxaoctanedioic acid | arachic acid |
| 1.371 | 3,6-dioxaoctanedioic acid | behenic acid |
| 1.372 | 3,6-dioxaoctanedioic acid | lignoceric acid |
| 1.373 | 3,6-dioxaoctanedioic acid | montanic acid |
| 1.374 | 3,6-dioxaoctanedioic acid | undecylenic acid |
| 1.375 | 3,6-dioxaoctanedioic acid | myristoleic acid |
| 1.376 | 3,6-dioxaoctanedioic acid | palmitoleic acid |
| 1.377 | 3,6-dioxaoctanedioic acid | petroselic acid |
| 1.378 | 3,6-dioxaoctanedioic acid | oleic acid |
| 1.379 | 3,6-dioxaoctanedioic acid | elaidic acid |
| 1.380 | 3,6-dioxaoctanedioic acid | icosenic acid |
| 1.381 | 3,6-dioxaoctanedioic acid | cetoleic acid |
| 1.382 | 3,6-dioxaoctanedioic acid | erucic acid |
| 1.383 | 3,6-dioxaoctanedioic acid | nervonic acid |
| 1.384 | 3,6-dioxaoctanedioic acid | linoleic acid |
| 1.385 | 3,6-dioxaoctanedioic acid | alpha-linolenic acid |
| 1.386 | 3,6-dioxaoctanedioic acid | calendic acid |
| 1.387 | 3,6-dioxaoctanedioic acid | punicic acid |
| 1.388 | 3,6-dioxaoctanedioic acid | alpha-eleostearic acid |
| 1.389 | 3,6-dioxaoctanedioic acid | arachidonic acid |
| 1.390 | 3,6-dioxaoctanedioic acid | timnodonic acid |
| 1.391 | 3,6-dioxaoctanedioic acid | clupanodonic acid |
| 1.392 | 3,6-dioxaoctanedioic acid | ricinoleic acid |
| 1.393 | glutamic acid | lauric acid |
| 1.394 | glutamic acid | myristic acid |
| 1.395 | glutamic acid | palmitic acid |
| 1.396 | glutamic acid | margaric acid |
| 1.397 | glutamic acid | stearic acid |
| 1.398 | glutamic acid | arachic acid |
| 1.399 | glutamic acid | behenic acid |
| 1.400 | glutamic acid | lignoceric acid |
| 1.401 | glutamic acid | montanic acid |
| 1.402 | glutamic acid | undecylenic acid |
| 1.403 | glutamic acid | myristoleic acid |
| 1.404 | glutamic acid | palmitoleic acid |
| 1.405 | glutamic acid | petroselic acid |
| 1.406 | glutamic acid | oleic acid |
| 1.407 | glutamic acid | elaidic acid |
| 1.408 | glutamic acid | icosenic acid |
| 1.409 | glutamic acid | cetoleic acid |
| 1.410 | glutamic acid | erucic acid |
| 1.411 | glutamic acid | nervonic acid |
| 1.412 | glutamic acid | linoleic acid |
| 1.413 | glutamic acid | alpha-linolenic acid |
| 1.414 | glutamic acid | calendic acid |
| 1.415 | glutamic acid | punicic acid |
| 1.416 | glutamic acid | alpha-eleostearic acid |
| 1.417 | glutamic acid | arachidonic acid |
| 1.418 | glutamic acid | timnodonic acid |
| 1.419 | glutamic acid | clupanodonic acid |
| 1.420 | glutamic acid | ricinoleic acid |
| 1.421 | cis-propene-1,2,3-tricarboxylic acid | lauric acid |
| 1 422 | cis-propene-1,2,3-tricarboxylic acid | myristic acid |
| 1.423 | cis-propene-1,2,3-tricarboxylic acid | palmitic acid |
| 1.424 | cis-propene-1,2,3-tricarboxylic acid | margaric acid |
| 1.425 | cis-propene-1,2,3-tricarboxylic acid | stearic acid |
| 1.426 | cis-propene-1,2,3-tricarboxylic acid | arachic acid |
| 1.427 | cis-propene-1,2,3-tricarboxylic acid | behenic acid |
| 1.428 | cis-propene-1,2,3-tricarboxylic acid | lignoceric acid |
| 1.429 | cis-propene-1,2,3-tricarboxylic acid | montanic acid |
| 1.430 | cis-propene-1,2,3-tricarboxylic acid | undecylenic acid |
| 1.431 | cis-propene-1,2,3-tricarboxylic acid | myristoleic acid |
| 1.432 | cis-propene-1,2,3-tricarboxylic acid | palmitoleic acid |
| 1.433 | cis-propene-1,2,3-tricarboxylic acid | petroselic acid |
| 1.434 | cis-propene-1,2,3-tricarboxylic acid | oleic acid |
| 1.435 | cis-propene-1,2,3-tricarboxylic acid | elaidic acid |
| 1.436 | cis-propene-1,2,3-tricarboxylic acid | icosenic acid |
| 1.437 | cis-propene-1,2,3-tricarboxylic acid | cetoleic acid |
| 1.438 | cis-propene-1,2,3-tricarboxylic acid | erucic acid |
| 1.439 | cis-propene-1,2,3-tricarboxylic acid | nervonic acid |
| 1.440 | cis-propene-1,2,3-tricarboxylic acid | linoleic acid |
| 1.441 | cis-propene-1,2,3-tricarboxylic acid | alpha-linolenic acid |
| 1.442 | cis-propene-1,2,3-tricarboxylic acid | calendic acid |
| 1.443 | cis-propene-1,2,3-tricarboxylic acid | punicic acid |
| 1.444 | cis-propene-1,2,3-tricarboxylic acid | alpha-eleostearic acid |
| 1.445 | cis-propene-1,2,3-tricarboxylic acid | arachidonic acid |
| 1.446 | cis-propene-1,2,3-tricarboxylic acid | timnodonic acid |
| 1.447 | cis-propene-1,2,3-tricarboxylic acid | clupanodonic acid |
| 1.448 | cis-propene-1,2,3-tricarboxylic acid | ricinoleic acid |
| 1.449 | 2,2-dimethylbutanedioic acid | lauric acid |
| 1.450 | 2,2-dimethylbutanedioic acid | myristic acid |
| 1.451 | 2,2-dimethylbutanedioic acid | palmitic acid |
| 1.452 | 2,2-dimethylbutanedioic acid | margaric acid |
| 1.453 | 2,2-dimethylbutanedioic acid | stearic acid |
| 1.454 | 2,2-dimethylbutanedioic acid | arachic acid |
| 1.455 | 2,2-dimethylbutanedioic acid | behenic acid |
| 1.456 | 2,2-dimethylbutanedioic acid | lignoceric acid |
| 1.457 | 2,2-dimethylbutanedioic acid | montanic acid |
| 1.458 | 2,2-dimethylbutanedioic acid | undecylenic acid |
| 1.459 | 2,2-dimethylbutanedioic acid | myristoleic acid |
| 1.460 | 2,2-dimethylbutanedioic acid | palmitoleic acid |
| 1.461 | 2,2-dimethylbutanedioic acid | petroselic acid |
| 1.462 | 2,2-dimethylbutanedioic acid | oleic acid |
| 1.463 | 2,2-dimethylbutanedioic acid | elaidic acid |
| 1.464 | 2,2-dimethylbutanedioic acid | icosenic acid |
| 1.465 | 2,2-dimethylbutanedioic acid | cetoleic acid |
| 1.466 | 2,2-dimethylbutanedioic acid | erucic acid |
| 1.467 | 2,2-dimethylbutanedioic acid | nervonic acid |
| 1.468 | 2,2-dimethylbutanedioic acid | linoleic acid |
| 1.469 | 2,2-dimethylbutanedioic acid | alpha-linolenic acid |
| 1.470 | 2,2-dimethylbutanedioic acid | calendic acid |
| 1.471 | 2,2-dimethylbutanedioic acid | punicic acid |
| 1.472 | 2,2-dimethylbutanedioic acid | alpha-eleostearic acid |
| 1.473 | 2,2-dimethylbutanedioic acid | arachidonic acid |
| 1.474 | 2,2-dimethylbutanedioic acid | timnodonic acid |
| 1.475 | 2,2-dimethylbutanedioic acid | clupanodonic acid |
| 1.476 | 2,2-dimethylbutanedioic acid | ricinoleic acid |
| 1.477 | 2-methylglutaric acid | lauric acid |
| 1.478 | 2-methylglutaric acid | myristic acid |
| 1.479 | 2-methylglutaric acid | palmitic acid |
| 1.480 | 2-methylglutaric acid | margaric acid |
| 1.481 | 2-methylglutaric acid | stearic acid |
| 1.482 | 2-methylglutaric acid | arachic acid |
| 1.483 | 2-methylglutaric acid | behenic acid |
| 1.484 | 2-methylglutaric acid | lignoceric acid |
| 1.485 | 2-methylglutaric acid | montanic acid |
| 1.486 | 2-methylglutaric acid | undecylenic acid |
| 1.487 | 2-methylglutaric acid | myristoleic acid |
| 1.488 | 2-methylglutaric acid | palmitoleic acid |
| 1.489 | 2-methylglutaric acid | petroselic acid |
| 1.490 | 2-methylglutaric acid | oleic acid |
| 1.491 | 2-methylglutaric acid | elaidic acid |
| 1.492 | 2-methylglutaric acid | icosenic acid |
| 1.493 | 2-methylglutaric acid | cetoleic acid |
| 1.494 | 2-methylglutaric acid | erucic acid |
| 1.495 | 2-methylglutaric acid | nervonic acid |
| 1.496 | 2-methylglutaric acid | linoleic acid |
| 1.497 | 2-methylglutaric acid | alpha-linolenic acid |
| 1.498 | 2-methylglutaric acid | calendic acid |
| 1.499 | 2-methylglutaric acid | punicic acid |
| 1.500 | 2-methylglutaric acid | alpha-eleostearic acid |
| 1.501 | 2-methylglutaric acid | arachidonic acid |
| 1.502 | 2-methylglutaric acid | timnodonic acid |
| 1.503 | 2-methylglutaric acid | clupanodonic acid |
| 1.504 | 2-methylglutaric acid | ricinoleic acid |
| 1.505 | citric acid | lauric acid |
| 1.506 | citric acid | myristic acid |
| 1.507 | citric acid | palmitic acid |
| 1.508 | citric acid | margaric acid |
| 1.509 | citric acid | stearic acid |
| 1.510 | citric acid | arachic acid |
| 1.511 | citric acid | behenic acid |
| 1.512 | citric acid | lignoceric acid |
| 1.513 | citric acid | montanic acid |
| 1.514 | citric acid | undecylenic acid |
| 1.515 | citric acid | myristoleic acid |
| 1.516 | citric acid | palmitoleic acid |
| 1.517 | citric acid | petroselic acid |
| 1.518 | citric acid | oleic acid |
| 1.519 | citric acid | elaidic acid |
| 1.520 | citric acid | icosenic acid |
| 1.521 | citric acid | cetoleic acid |
| 1.522 | citric acid | erucic acid |
| 1.523 | citric acid | nervonic acid |
| 1.524 | citric acid | linoleic acid |
| 1.525 | citric acid | alpha-linolenic acid |
| 1.526 | citric acid | calendic acid |
| 1.527 | citric acid | punicic acid |
| 1.528 | citric acid | alpha-eleostearic acid |
| 1.529 | citric acid | arachidonic acid |
| 1.530 | citric acid | timnodonic acid |
| 1.531 | citric acid | clupanodonic acid |
| 1.532 | citric acid | ricinoleic acid |
| 1.533 | 2,3,4,5-tetrahydroxyhexanoic acid | lauric acid |
| 1.534 | 2,3,4,5-tetrahydroxyhexanoic acid | myristic acid |
| 1.535 | 2,3,4,5-tetrahydroxyhexanoic acid | palmitic acid |
| 1.536 | 2,3,4,5-tetrahydroxyhexanoic acid | margaric acid |
| 1.537 | 2,3,4,5-tetrahydroxyhexanoic acid | stearic acid |
| 1.538 | 2,3,4,5-tetrahydroxyhexanoic acid | arachic acid |
| 1.539 | 2,3,4,5-tetrahydroxyhexanoic acid | behenic acid |
| 1.540 | 2,3,4,5-tetrahydroxyhexanoic acid | lignoceric acid |
| 1.541 | 2,3,4,5-tetrahydroxyhexanoic acid | montanic acid |
| 1.542 | 2,3,4,5-tetrahydroxyhexanoic acid | undecylenic acid |
| 1.543 | 2,3,4,5-tetrahydroxyhexanoic acid | myristoleic acid |
| 1.544 | 2,3,4,5-tetrahydroxyhexanoic acid | palmitoleic acid |
| 1.545 | 2,3,4,5-tetrahydroxyhexanoic acid | petroselic acid |
| 1.546 | 2,3,4,5-tetrahydroxyhexanoic acid | oleic acid |
| 1.547 | 2,3,4,5-tetrahydroxyhexanoic acid | elaidic acid |
| 1.548 | 2,3,4,5-tetrahydroxyhexanoic acid | icosenic acid |
| 1.549 | 2,3,4,5-tetrahydroxyhexanoic acid | cetoleic acid |
| 1.550 | 2,3,4,5-tetrahydroxyhexanoic acid | erucic acid |
| 1.551 | 2,3,4,5-tetrahydroxyhexanoic acid | nervonic acid |
| 1.552 | 2,3,4,5-tetrahydroxyhexanoic acid | linoleic acid |
| 1.553 | 2,3,4,5-tetrahydroxyhexanoic acid | alpha-linolenic acid |
| 1.554 | 2,3,4,5-tetrahydroxyhexanoic acid | calendic acid |
| 1.555 | 2,3,4,5-tetrahydroxyhexanoic acid | punicic acid |
| 1.556 | 2,3,4,5-tetrahydroxyhexanoic acid | alpha-eleostearic acid |
| 1.557 | 2,3,4,5-tetrahydroxyhexanoic acid | arachidonic acid |
| 1.558 | 2,3,4,5-tetrahydroxyhexanoic acid | timnodonic acid |
| 1.559 | 2,3,4,5-tetrahydroxyhexanoic acid | clupanodonic acid |
| 1.560 | 2,3,4,5-tetrahydroxyhexanoic acid | ricinoleic acid |
| 1.561 | butylmalonic acid | lauric acid |
| 1.562 | butylmalonic acid | myristic acid |
| 1.563 | butylmalonic acid | palmitic acid |
| 1.564 | butylmalonic acid | margaric acid |
| 1.565 | butylmalonic acid | stearic acid |
| 1.566 | butylmalonic acid | arachic acid |
| 1.567 | butylmalonic acid | behenic acid |
| 1.568 | butylmalonic acid | lignoceric acid |
| 1.569 | butylmalonic acid | montanic acid |
| 1.570 | butylmalonic acid | undecylenic acid |
| 1.571 | butylmalonic acid | myristoleic acid |
| 1.572 | butylmalonic acid | palmitoleic acid |
| 1.573 | butylmalonic acid | petroselic acid |
| 1.574 | butylmalonic acid | oleic acid |
| 1.575 | butylmalonic acid | elaidic acid |
| 1.576 | butylmalonic acid | icosenic acid |
| 1.577 | butylmalonic acid | cetoleic acid |
| 1.578 | butylmalonic acid | erucic acid |
| 1.579 | butylmalonic acid | nervonic acid |
| 1.580 | butylmalonic acid | linoleic acid |
| 1.581 | butylmalonic acid | alpha-linolenic acid |
| 1.582 | butylmalonic acid | calendic acid |
| 1.583 | butylmalonic acid | punicic acid |
| 1.584 | butylmalonic acid | alpha-eleostearic acid |
| 1.585 | butylmalonic acid | arachidonic acid |
| 1.586 | butylmalonic acid | timnodonic acid |
| 1.587 | butylmalonic acid | clupanodonic acid |
| 1.588 | butylmalonic acid | ricinoleic acid |
| 1.589 | tetrahydroxyheptanoic acid | lauric acid |
| 1.590 | tetrahydroxyheptanoic acid | myristic acid |
| 1.591 | tetrahydroxyheptanoic acid | palmitic acid |
| 1.592 | tetrahydroxyheptanoic acid | margaric acid |
| 1.593 | tetrahydroxyheptanoic acid | stearic acid |
| 1.594 | tetrahydroxyheptanoic acid | arachic acid |
| 1.595 | tetrahydroxyheptanoic acid | behenic acid |
| 1.596 | tetrahydroxyheptanoic acid | lignoceric acid |
| 1.597 | tetrahydroxyheptanoic acid | montanic acid |
| 1.598 | tetrahydroxyheptanoic acid | undecylenic acid |
| 1.599 | tetrahydroxyheptanoic acid | myristoleic acid |
| 1.600 | tetrahydroxyheptanoic acid | palmitoleic acid |
| 1.601 | tetrahydroxyheptanoic acid | petroselic acid |
| 1.602 | tetrahydroxyheptanoic acid | oleic acid |
| 1.603 | tetrahydroxyheptanoic acid | elaidic acid |
| 1.604 | tetrahydroxyheptanoic acid | icosenic acid |
| 1.605 | tetrahydroxyheptanoic acid | cetoleic acid |
| 1.606 | tetrahydroxyheptanoic acid | erucic acid |
| 1.607 | tetrahydroxyheptanoic acid | nervonic acid |
| 1.608 | tetrahydroxyheptanoic acid | linoleic acid |
| 1.609 | tetrahydroxyheptanoic acid | alpha-linolenic acid |
| 1.610 | tetrahydroxyheptanoic acid | calendic acid |
| 1.611 | tetrahydroxyheptanoic acid | punicic acid |
| 1.612 | tetrahydroxyheptanoic acid | alpha-eleostearic acid |
| 1.613 | tetrahydroxyheptanoic acid | arachidonic acid |
| 1.614 | tetrahydroxyheptanoic acid | timnodonic acid |
| 1.615 | tetrahydroxyheptanoic acid | clupanodonic acid |
| 1.616 | tetrahydroxyheptanoic acid | ricinoleic acid |
| 1.617 | 2-[2-(methoxyethoxy)ethoxy]acetic acid | lauric acid |
| 1.618 | 2-[2-(methoxyethoxy)ethoxy]acetic acid | myristic acid |
| 1.619 | 2-[2-(methoxyethoxy)ethoxy]acetic acid | palmitic acid |
| 1.620 | 2-[2-(methoxyethoxy)ethoxy]acetic acid | margaric acid |
| 1.621 | 2-[2-(methoxyethoxy)ethoxy]acetic acid | stearic acid |
| 1.622 | 2-[2-(methoxyethoxy)ethoxy]acetic acid | arachic acid |
| 1.623 | 2-[2-(methoxyethoxy)ethoxy]acetic acid | behenic acid |
| 1.624 | 2-[2-(methoxyethoxy)ethoxy]acetic acid | lignoceric acid |
| 1.625 | 2-[2-(methoxyethoxy)ethoxy]acetic acid | montanic acid |
| 1.626 | 2-[2-(methoxyethoxy)ethoxy]acetic acid | undecylenic acid |
| 1.627 | 2-[2-(methoxyethoxy)ethoxy]acetic acid | myristoleic acid |
| 1.628 | 2-[2-(methoxyethoxy)ethoxy]acetic acid | palmitoleic acid |
| 1.629 | 2-[2-(methoxyethoxy)ethoxy]acetic acid | petroselic acid |
| 1.630 | 2-[2-(methoxyethoxy)ethoxy]acetic acid | oleic acid |
| 1.631 | 2-[2-(methoxyethoxy)ethoxy]acetic acid | elaidic acid |
| 1.632 | 2-[2-(methoxyethoxy)ethoxy]acetic acid | icosenic acid |
| 1.633 | 2-[2-(methoxyethoxy)ethoxy]acetic acid | cetoleic acid |
| 1.634 | 2-[2-(methoxyethoxy)ethoxy]acetic acid | erucic acid |
| 1.635 | 2-[2-(methoxyethoxy)ethoxy]acetic acid | nervonic acid |
| 1.636 | 2-[2-(methoxyethoxy)ethoxy]acetic acid | linoleic acid |
| 1.637 | 2-[2-(methoxyethoxy)ethoxy]acetic acid | alpha-linolenic acid |
| 1.638 | 2-[2-(methoxyethoxy)ethoxy]acetic acid | calendic acid |
| 1.639 | 2-[2-(methoxyethoxy)ethoxy]acetic acid | punicic acid |
| 1.640 | 2-[2-(methoxyethoxy)ethoxy]acetic acid | alpha-eleostearic acid |
| 1.641 | 2-[2-(methoxyethoxy)ethoxy]acetic acid | arachidonic acid |
| 1.642 | 2-[2-(methoxyethoxy)ethoxy]acetic acid | timnodonic acid |
| 1.643 | 2-[2-(methoxyethoxy)ethoxy]acetic acid | clupanodonic acid |
| 1.644 | 2-[2-(methoxyethoxy)ethoxy]acetic acid | ricinoleic acid |
| 1.645 | acelaic acid | lauric acid |
| 1.646 | acelaic acid | myristic acid |
| 1.647 | acelaic acid | palmitic acid |
| 1.648 | acelaic acid | margaric acid |
| 1.649 | acelaic acid | stearic acid |
| 1.650 | acelaic acid | arachic acid |
| 1.651 | acelaic acid | behenic acid |
| 1.652 | acelaic acid | lignoceric acid |
| 1.653 | acelaic acid | montanic acid |
| 1.654 | acelaic acid | undecylenic acid |
| 1.655 | acelaic acid | myristoleic acid |
| 1.656 | acelaic acid | palmitoleic acid |
| 1.657 | acelaic acid | petroselic acid |
| 1.658 | acelaic acid | oleic acid |
| 1.659 | acelaic acid | elaidic acid |
| 1.660 | acelaic acid | icosenic acid |
| 1.661 | acelaic acid | cetoleic acid |
| 1.662 | acelaic acid | erucic acid |
| 1.663 | acelaic acid | nervonic acid |
| 1.664 | acelaic acid | linoleic acid |
| 1.665 | acelaic acid | alpha-linolenic acid |
| 1.666 | acelaic acid | calendic acid |
| 1.667 | acelaic acid | punicic acid |
| 1.668 | acelaic acid | alpha-eleostearic acid |
| 1.669 | acelaic acid | arachidonic acid |
| 1.670 | acelaic acid | timnodonic acid |
| 1.671 | acelaic acid | clupanodonic acid |
| 1.672 | acelaic acid | ricinoleic acid |
| 1.673 | (3R,4S,5R)-3,4,5-trihydroxy-1- | lauric acid |
| | cyclohexenecarboxylic acid | |
| 1.674 | (3R,4S,5R)-3,4,5-trihydroxy-1- | myristic acid |
| | cyclohexenecarboxylic acid | |
| 1.675 | (3R,4S,5R)-3,4,5-trihydroxy-1- | palmitic acid |
| | cyclohexenecarboxylic acid | |
| 1.676 | (3R,4S,5R)-3,4,5-trihydroxy-1- | margaric acid |
| | cyclohexenecarboxylic acid | |
| 1.677 | (3R,4S,5R)-3,4,5-trihydroxy-1- | stearic acid |
| | cyclohexenecarboxylic acid | |
| 1.678 | (3R,4S,5R)-3,4,5-trihydroxy-1- | arachic acid |
| | cyclohexenecarboxylic acid | |
| 1.679 | (3R,4S,5R)-3,4,5-trihydroxy-1- | behenic acid |
| | cyclohexenecarboxylic acid | |
| 1.680 | (3R,4S,5R)-3,4,5-trihydroxy-1- | lignoceric acid |
| | cyclohexenecarboxylic acid | |
| 1.681 | (3R,4S,5R)-3,4,5-trihydroxy-1- | montanic acid |
| | cyclohexenecarboxylic acid | |
| 1.682 | (3R,4S,5R)-3,4,5-trihydroxy-1- | undecylenic acid |
| | cyclohexenecarboxylic acid | |
| 1.683 | (3R,4S,5R)-3,4,5-trihydroxy-1- | myristoleic acid |
| | cyclohexenecarboxylic acid | |
| 1.684 | (3R,4S,5R)-3,4,5-trihydroxy-1- | palmitoleic acid |
| | cyclohexenecarboxylic acid | |
| 1.685 | (3R,4S,5R)-3,4,5-trihydroxy-1- | petroselic acid |
| | cyclohexenecarboxylic acid | |
| 1.686 | (3R,4S,5R)-3,4,5-trihydroxy-1- | oleic acid |
| | cyclohexenecarboxylic acid | |
| 1.687 | (3R,4S,5R)-3,4,5-trihydroxy-1- | elaidic acid |
| | cyclohexenecarboxylic acid | |
| 1.688 | (3R,4S,5R)-3,4,5-trihydroxy-1- | icosenic acid |
| | cyclohexenecarboxylic acid | |
| 1.689 | (3R,4S,5R)-3,4,5-trihydroxy-1- | cetoleic acid |
| | cyclohexenecarboxylic acid | |
| 1.690 | (3R,4S,5R)-3,4,5-trihydroxy-1- | erucic acid |
| | cyclohexenecarboxylic acid | |
| 1.691 | (3R,4S,5R)-3,4,5-trihydroxy-1- | nervonic acid |
| | cyclohexenecarboxylic acid | |
| 1.692 | (3R,4S,5R)-3,4,5-trihydroxy-1- | linoleic acid |
| | cyclohexenecarboxylic acid | |
| 1.693 | (3R,4S,5R)-3,4,5-trihydroxy-1- | alpha-linolenic acid |
| | cyclohexenecarboxylic acid | |
| 1.694 | (3R,4S,5R)-3,4,5-trihydroxy-1- | calendic acid |
| | cyclohexenecarboxylic acid | |
| 1.695 | (3R,4S,5R)-3,4,5-trihydroxy-1- | punicic acid |
| | cyclohexenecarboxylic acid | |
| 1.696 | (3R,4S,5R)-3,4,5-trihydroxy-1- | alpha-eleostearic acid |
| | cyclohexenecarboxylic acid | |
| 1.697 | (3R,4S,5R)-3,4,5-trihydroxy-1- | arachidonic acid |
| | cyclohexenecarboxylic acid | |
| 1.698 | (3R,4S,5R)-3,4,5-trihydroxy-1- | timnodonic acid |
| | cyclohexenecarboxylic acid | |
| 1.699 | (3R,4S,5R)-3,4,5-trihydroxy-1- | clupanodonic acid |
| | cyclohexenecarboxylic acid | |
| 1.700 | (3R,4S,5R)-3,4,5-trihydroxy-1- | ricinoleic acid |
| | cyclohexenecarboxylic acid | |

Table 2

Table 2 consists of 700 combinations of the long-chained and short-chained carboxylic acids as described above in Table 1, the short-chained carboxylic acid being present as a sodium salt. In the case of carboxylic acids with several acid functions, all the acid functions are present in salt form.

Table 3

Table 3 consists of 700 combinations of the long-chained and short-chained carboxylic acids as described above in Table 1, the short-chained carboxylic acid being present as a potassium salt. In the case of carboxylic acids with several acid functions, all the acid functions are present in salt form.

Table 4

Table 4 consists of 700 combinations of the long-chained and short-chained carboxylic acids as described above in Table 1, the short-chained carboxylic acid being present as a zirconium salt. In the case of carboxylic acids with several acid functions, all the acid functions are present in salt form.

Table 5

Table 5 consists of 700 combinations of the long-chained and short-chained carboxylic acids as described above in Table 1, the short-chained carboxylic acid being present as an ammonium salt. In the case of carboxylic acids with several acid functions, all the acid functions are present in salt form.

Table 6

Table 6 consists of 700 combinations of the long-chained and short-chained carboxylic acids as described above in Table 1, the short-chained carboxylic acid being present as a yttrium salt. In the case of carboxylic acids with several acid functions, all the acid functions are present in salt form.

These acids and the salts thereof can serve both to adjust the pH and, in the partly or completely neutralized form, for example, with ammonia or water-soluble amines, to buffer the pH. This can improve the controlling of the viscosity and stability of the dispersion.

The carboxylic acid formulation can, for example, be added to the suspension before the drying. If the particle size of the zirconium oxide in the suspension is adjusted by grinding zirconium oxide, the carboxylic acid formulation can also be added at any desired point in time during the grinding step, such as towards the middle or end of the grinding step. It is also possible to add the various contents of the carboxylic acid formulation at various points in time. For example, the addition can occur before the drying, the suspension of the zirconium oxide thereby being stirred or subjected to shearing forces or otherwise mixed in itself and with the carboxylic acid formulation.

The state of the carboxylic acids before and after the drying and the mode of action thereof cannot be defined precisely. It is presumed that any short-chained carboxylic acids present are dissolved in the water or are adsorbed onto the surface of the ceramic particles, the acid carboxyl group undergoing bonding with the alkaline surface of the zirconium oxide particle. If the short-chained carboxylic acid is partly neutralized, ammonium ions would be liberated, which raise the pH of the solution, which can also be observed in practice (such as in Example 2). The long-chained carboxylic acid could form micelles, in the center of which there could be one or more zirconium oxide particles. In this context, the carboxyl group of the long-chained carboxylic acid could be on the surface of the micelles, while the alkyl radical points inwards and undergoes a weak interaction with the enclosed ceramic particle(s), which is possibly covered by a layer of adsorbate. If these micelles are retained during the drying, the ceramic particles are hydrophobized and can no longer form encrustations during drying, which would explain the effect of the good plastic deformability of the granules of Examples 2 and 3. Precise studies on the action mechanism are difficult, however, and require involved methods, since the concentration of carboxyl group is too low for an analysis with known methods.

Polyelectrolytes, such as polyacrylic acid or salts thereof, are not carboxylic acids in the context of the present invention, but can be used as binders in the context of the present invention.

The formulation according to the present invention also contains a binder which ensures the stability of the compact. Examples of a binder are polymers, for example, polymers which have a ceiling temperature of 220° C. or of 200° C. or less, for example, polyethers, such as polyethylene glycols (having, for example, a molecular weight of from 1,000 to 10,000), polyoxymethylene, polytetrahydrofuran, polyvinyl alcohols and esters thereof, such as polyvinyl acetate (with any desired degree of saponification), polyvinylpyrilidone, polyvinylimine, polyacrylic acids and esters thereof, such as polymethyl methacrylate, polyethyl methacrylate, polybutyl methacrylate, poly-tert-butyl methacrylate, polyisobutyl methacrylate, polymethyl acrylate, polyethyl acrylate, polybutyl acrylate, poly-tert-butyl acrylate, polyisobutyl acrylate, blends thereof and copolymers, but also cellulose, starch, derivatives thereof and mixtures or copolymers of the abovementioned polymers. Thus, for example, polyvinyl alcohol-co-polyvinyl acetate, polymethyl methacrylate-co-polymethyl acrylate or polymethyl methacrylate-co-polybutyl acrylate can also be used. Advantageous binders can be burned out in a controlled manner without residue, such as, for example, polyvinyl alcohol, polyacetal and polyvinyl acetate. However, it is also possible to use compositions of the two individual polymers, such as mixtures containing polyvinyl alcohol and polyvinyl acetate, polymethyl methacrylate and polymethyl acrylate or polymethyl methacrylate and polybutyl acrylate. These mixtures are can, for example, be present as suspensions or dispersions of the polymers in water and can be added together, simultaneously or sequentially with respect to the addition of the carboxylic acid(s), for example, sequentially after the addition of the carboxylic acids.

The content of binder can, for example, be in the range of from 0.1 wt. % to 7 wt. %, for example, from 0.1 wt. % to 5 wt. %, or from 0.5 wt. % to 3 wt. %, based on the finished powder.

If the addition of the carboxylic acid formulation sinks the pH so low that the zirconium oxide flocculates out as a result of a too low a zeta potential, the pH should be readjusted, for example, with sodium hydroxide solution, potassium hydroxide solution, blowing in gaseous ammonia or addition of aqueous ammonia, or carboxylic acid formulations which are partly neutralized (advantageously with ammonia), that is to say salts, should be used. The degree of neutralization required can be determined by the person skilled in the art by monitoring the zeta potential of the dispersion.

In the following tables, suitable combinations of carboxylic acids and binders are shown and combinations of short-chained carboxylic acids with long-chained carboxylic acids and formulations thereof with suitable binders are provided. Individual combinations are designated by the number of the table, followed by the number of the particular combination in Table 1. For example, combination 7.005 means the combination of the carboxylic acids as in Table 1, position no. 5 with the form given in Table 7 in which the carboxylic acid is present (here: free carboxylic acid) and the binder shown in Table 7 (here: polyvinyl acetate). In combination 7.005, oxalic acid is thus employed as the long-chained carboxylic acid, stearic acid as the short-chained carboxylic acid and polyvinyl acetate as the binder, the oxalic acid being employed as the free carboxylic acid.

Table 7

Table 7 consists of 700 combinations of the long-chained and short-chained carboxylic acids as described above in Table 1, the short-chained carboxylic acid being present as a free carboxylic acid. Polyvinyl acetate is in each case employed as the binder.

Table 8

Table 8 consists of 700 combinations of the long-chained and short-chained carboxylic acids as described above in Table 1, the short-chained carboxylic acid being present as a sodium salt and carboxylic acids with several acid functions, all the acid functions being present in salt form. Polyvinyl acetate is in each case employed as the binder.

Table 9

Table 9 consists of 700 combinations of the long-chained and short-chained carboxylic acids as described above in Table 1, the short-chained carboxylic acid being present as a potassium salt and carboxylic acids with several acid functions, all the acid functions being present in salt form. Polyvinyl acetate is in each case employed as the binder.

Table 10

Table 10 consists of 700 combinations of the long-chained and short-chained carboxylic acids as described above in Table 1, the short-chained carboxylic acid being present as a zirconium salt and carboxylic acids with several acid functions, all the acid functions being present in salt form. Polyvinyl acetate is in each case employed as the binder.

Table 11

Table 11 consists of 700 combinations of the long-chained and short-chained carboxylic acids as described above in Table 1, the short-chained carboxylic acid being present as an ammonium salt and carboxylic acids with several acid functions, all the acid functions being present in salt form. Polyvinyl acetate is in each case employed as the binder.

Table 12

Table 12 consists of 700 combinations of the long-chained and short-chained carboxylic acids as described above in Table 1, the short-chained carboxylic acid being present as a yttrium salt and carboxylic acids with several acid functions, all the acid functions being present in salt form. Polyvinyl acetate is in each case employed as the binder.

Table 13

Table 13 consists of 700 combinations of the long-chained and short-chained carboxylic acids as described above in Table 1, the short-chained carboxylic acid being present as a free carboxylic acid. Polyvinyl alcohol is in each case employed as the binder.

Table 14

Table 14 consists of 700 combinations of the long-chained and short-chained carboxylic acids as described above in Table 1, the short-chained carboxylic acid being present as a sodium salt and carboxylic acids with several acid functions, all the acid functions being present in salt form. Polyvinyl alcohol is in each case employed as the binder.

Table 15

Table 15 consists of 700 combinations of the long-chained and short-chained carboxylic acids as described above in Table 1, the short-chained carboxylic acid being present as a potassium salt and carboxylic acids with several acid functions, all the acid functions being present in salt form. Polyvinyl alcohol is in each case employed as the binder.

Table 16

Table 16 consists of 700 combinations of the long-chained and short-chained carboxylic acids as described above in Table 1, the short-chained carboxylic acid being present as a zirconium salt and carboxylic acids with several acid functions, all the acid functions being present in salt form. Polyvinyl alcohol is in each case employed as the binder.

Table 17

Table 17 consists of 700 combinations of the long-chained and short-chained carboxylic acids as described above in Table 1, the short-chained carboxylic acid being present as an ammonium salt and carboxylic acids with several acid functions, all the acid functions being present in salt form. Polyvinyl alcohol is in each case employed as the binder.

Table 18

Table 18 consists of 700 combinations of the long-chained and short-chained carboxylic acids as described above in Table 1, the short-chained carboxylic acid being present as a yttrium salt and carboxylic acids with several acid functions, all the acid functions being present in salt form. Polyvinyl alcohol is in each case employed as the binder.

Table 19

Table 19 consists of 700 combinations of the long-chained and short-chained carboxylic acids as described above in Table 1, the short-chained carboxylic acid being present as a free carboxylic acid. Polyacrylic acid is in each case employed as the binder.

Table 20

Table 20 consists of 700 combinations of the long-chained and short-chained carboxylic acids as described above in Table 1, the short-chained carboxylic acid being present as a sodium salt and carboxylic acids with several acid functions, all the acid functions being present in salt form. Polyacrylic acid is in each case employed as the binder.

Table 21

Table 21 consists of 700 combinations of the long-chained and short-chained carboxylic acids as described above in Table 1, the short-chained carboxylic acid being present as a potassium salt and carboxylic acids with several acid functions, all the acid functions being present in salt form. Polyacrylic acid is in each case employed as the binder.

Table 22

Table 22 consists of 700 combinations of the long-chained and short-chained carboxylic acids as described above in Table 1, the short-chained carboxylic acid being present as a zirconium salt and carboxylic acids with several acid functions, all the acid functions being present in salt form. Polyacrylic acid is in each case employed as the binder.

Table 23

Table 23 consists of 700 combinations of the long-chained and short-chained carboxylic acids as described above in Table 1, the short-chained carboxylic acid being present as an ammonium salt and carboxylic acids with several acid functions, all the acid functions being present in salt form. Polyacrylic acid is in each case employed as the binder.

Table 24

Table 24 consists of 700 combinations of the long-chained and short-chained carboxylic acids as described above in Table 1, the short-chained carboxylic acid being present as a yttrium salt and carboxylic acids with several acid functions, all the acid functions being present in salt form. Polyacrylic acid is in each case employed as the binder.

Table 25

Table 25 consists of 700 combinations of the long-chained and short-chained carboxylic acids as described above in Table 1, the short-chained carboxylic acid being present as a free carboxylic acid. Polymethyl methacrylate is in each case employed as the binder.

Table 26

Table 26 consists of 700 combinations of the long-chained and short-chained carboxylic acids as described above in Table 1, the short-chained carboxylic acid being present as a sodium salt and carboxylic acids with several acid functions, all the acid functions being present in salt form. Polymethyl methacrylate is in each case employed as the binder.

Table 27

Table 27 consists of 700 combinations of the long-chained and short-chained carboxylic acids as described above in Table 1, the short-chained carboxylic acid being present as a potassium salt and carboxylic acids with several acid functions, all the acid functions being present in salt form. Polymethyl methacrylate is in each case employed as the binder.

Table 28

Table 28 consists of 700 combinations of the long-chained and short-chained carboxylic acids as described above in Table 1, the short-chained carboxylic acid being present as a zirconium salt and carboxylic acids with several acid functions, all the acid functions being present in salt form. Polymethyl methacrylate is in each case employed as the binder.

Table 29

Table 29 consists of 700 combinations of the long-chained and short-chained carboxylic acids as described above in Table 1, the short-chained carboxylic acid being present as an ammonium salt and carboxylic acids with several acid functions, all the acid functions being present in salt form. Polymethyl methacrylate is in each case employed as the binder.

Table 30

Table 30 consists of 700 combinations of the long-chained and short-chained carboxylic acids as described above in Table 1, the short-chained carboxylic acid being present as a yttrium salt and carboxylic acids with several acid functions, all the acid functions being present in salt form. Polymethyl methacrylate is in each case employed as the binder.

Table 31

Table 31 consists of 700 combinations of the long-chained and short-chained carboxylic acids as described above in Table 1, the short-chained carboxylic acid being present as a free carboxylic acid. Polyethylene glycol (molecular weight 3,000) is in each case employed as the binder.

Table 32

Table 32 consists of 700 combinations of the long-chained and short-chained carboxylic acids as described above in Table 1, the short-chained carboxylic acid being present as a sodium salt and carboxylic acids with several acid functions, all the acid functions being present in salt form. Polyethylene glycol (molecular weight 3,000) is in each case employed as the binder.

Table 33

Table 33 consists of 700 combinations of the long-chained and short-chained carboxylic acids as described above in Table 1, the short-chained carboxylic acid being present as a potassium salt and carboxylic acids with several acid functions, all the acid functions being present in salt form. Polyethylene glycol (molecular weight 3,000) is in each case employed as the binder.

Table 34

Table 34 consists of 700 combinations of the long-chained and short-chained carboxylic acids as described above in Table 1, the short-chained carboxylic acid being present as a zirconium salt and carboxylic acids with several acid functions, all the acid functions being present in salt form. Polyethylene glycol (molecular weight 3,000) is in each case employed as the binder.

Table 35

Table 35 consists of 700 combinations of the long-chained and short-chained carboxylic acids as described above in Table 1, the short-chained carboxylic acid being present as an ammonium salt and carboxylic acids with several acid functions, all the acid functions being present in salt form. Polyethylene glycol (molecular weight 3,000) is in each case employed as the binder.

Table 36

Table 36 consists of 700 combinations of the long-chained and short-chained carboxylic acids as described above in Table 1, the short-chained carboxylic acid being present as a yttrium salt and carboxylic acids with several acid functions, all the acid functions being present in salt form. Polyethylene glycol (molecular weight 3,000) is in each case employed as the binder.

Table 37

Table 37 consists of 700 combinations of the long-chained and short-chained carboxylic acids as described above in Table 1, the short-chained carboxylic acid being present as a free carboxylic acid. Polyvinylimine is in each case employed as the binder.

Table 38

Table 38 consists of 700 combinations of the long-chained and short-chained carboxylic acids as described above in Table 1, the short-chained carboxylic acid being present as a sodium salt and carboxylic acids with several acid functions, all the acid functions being present in salt form. Polyvinylimine is in each case employed as the binder.

Table 39

Table 39 consists of 700 combinations of the long-chained and short-chained carboxylic acids as described above in Table 1, the short-chained carboxylic acid being present as a potassium salt and carboxylic acids with several acid functions, all the acid functions being present in salt form. Polyvinylimine is in each case employed as the binder.

Table 40

Table 40 consists of 700 combinations of the long-chained and short-chained carboxylic acids as described above in Table 1, the short-chained carboxylic acid being present as a zirconium salt and carboxylic acids with several acid functions, all the acid functions being present in salt form. Polyvinylimine is in each case employed as the binder.

Table 41

Table 41 consists of 700 combinations of the long-chained and short-chained carboxylic acids as described above in Table 1, the short-chained carboxylic acid being present as an ammonium salt and carboxylic acids with several acid functions, all the acid functions being present in salt form. Polyvinylimine is in each case employed as the binder.

Table 41

Table 41 consists of 700 combinations of the long-chained and short-chained carboxylic acids as described above in Table 1, the short-chained carboxylic acid being present as a yttrium salt and carboxylic acids with several acid functions, all the acid functions being present in salt form. Polyvinylimine is in each case employed as the binder.

Table 42

Table 42 consists of 700 combinations of the long-chained and short-chained carboxylic acids as described above in Table 1, the short-chained carboxylic acid being present as a free carboxylic acid. A polymethyl methacrylate-polymethyl acrylate blend is in each case employed as the binder.

Table 43

Table 43 consists of 700 combinations of the long-chained and short-chained carboxylic acids as described above in Table 1, the short-chained carboxylic acid being present as a sodium salt and carboxylic acids with several acid functions, all the acid functions being present in salt form. A polymethyl methacrylate-polymethyl acrylate blend is in each case employed as the binder.

Table 44

Table 44 consists of 700 combinations of the long-chained and short-chained carboxylic acids as described above in Table 1, the short-chained carboxylic acid being present as a potassium salt and carboxylic acids with several acid functions, all the acid functions being present in salt form. A polymethyl methacrylate-polymethyl acrylate blend is in each case employed as the binder.

Table 45

Table 45 consists of 700 combinations of the long-chained and short-chained carboxylic acids as described above in Table 1, the short-chained carboxylic acid being present as a zirconium salt and carboxylic acids with several acid functions, all the acid functions being present in salt form. A polymethyl methacrylate-polymethyl acrylate blend is in each case employed as the binder.

Table 46

Table 46 consists of 700 combinations of the long-chained and short-chained carboxylic acids as described above in Table 1, the short-chained carboxylic acid being present as an ammonium salt and carboxylic acids with several acid functions, all the acid functions being present in salt form. A polymethyl methacrylate-polymethyl acrylate blend is in each case employed as the binder.

Table 47

Table 47 consists of 700 combinations of the long-chained and short-chained carboxylic acids as described above in Table 1, the short-chained carboxylic acid being present as a yttrium salt and carboxylic acids with several acid functions, all the acid functions being present in salt form. A polymethyl methacrylate-polymethyl acrylate blend is in each case employed as the binder.

Table 48

Table 48 consists of 700 combinations of the long-chained and short-chained carboxylic acids as described above in Table 1, the short-chained carboxylic acid being present as a free carboxylic acid. A polybutyl acrylate-polymethyl methacrylate blend is in each case employed as the binder.

Table 49

Table 49 consists of 700 combinations of the long-chained and short-chained carboxylic acids as described above in Table 1, the short-chained carboxylic acid being present as a sodium salt and carboxylic acids with several acid functions, all the acid functions being present in salt form. A polybutyl acrylate-polymethyl methacrylate blend is in each case employed as the binder.

Table 50

Table 50 consists of 700 combinations of the long-chained and short-chained carboxylic acids as described above in Table 1, the short-chained carboxylic acid being present as a potassium salt and carboxylic acids with several acid functions, all the acid functions being present in salt form. A polybutyl acrylate-polymethyl methacrylate blend is in each case employed as the binder.

Table 51

Table 51 consists of 700 combinations of the long-chained and short-chained carboxylic acids as described above in Table 1, the short-chained carboxylic acid being present as a zirconium salt and carboxylic acids with several acid functions, all the acid functions being present in salt form. A polybutyl acrylate-polymethyl methacrylate blend is in each case employed as the binder.

Table 52

Table 52 consists of 700 combinations of the long-chained and short-chained carboxylic acids as described above in Table 1, the short-chained carboxylic acid being present as an ammonium salt and carboxylic acids with several acid functions, all the acid functions being present in salt form. A polybutyl acrylate-polymethyl methacrylate blend is in each case employed as the binder.

Table 53

Table 53 consists of 700 combinations of the long-chained and short-chained carboxylic acids as described above in Table 1, the short-chained carboxylic acid being present as a yttrium salt and carboxylic acids with several acid functions, all the acid functions being present in salt form. A polybutyl acrylate-polymethyl methacrylate blend is in each case employed as the binder.

Table 54

Table 54 consists of 700 combinations of the long-chained and short-chained carboxylic acids as described above in Table 1, the short-chained carboxylic acid being present as a free carboxylic acid. Polybutyl methacrylate is in each case employed as the binder.

Table 55

Table 55 consists of 700 combinations of the long-chained and short-chained carboxylic acids as described above in Table 1, the short-chained carboxylic acid being present as a sodium salt and carboxylic acids with several acid functions, all the acid functions being present in salt form. Polybutyl methacrylate is in each case employed as the binder.

Table 56

Table 56 consists of 700 combinations of the long-chained and short-chained carboxylic acids as described above in Table 1, the short-chained carboxylic acid being present as a potassium salt and carboxylic acids with several acid functions, all the acid functions being present in salt form. Polybutyl methacrylate is in each case employed as the binder.

Table 57

Table 57 consists of 700 combinations of the long-chained and short-chained carboxylic acids as described above in Table 1, the short-chained carboxylic acid being present as a zirconium salt and carboxylic acids with several acid functions, all the acid functions being present in salt form. Polybutyl methacrylate is in each case employed as the binder.

Table 58

Table 58 consists of 700 combinations of the long-chained and short-chained carboxylic acids as described above in Table 1, the short-chained carboxylic acid being present as an ammonium salt and carboxylic acids with several acid functions, all the acid functions being present in salt form. Polybutyl methacrylate is in each case employed as the binder.

Table 59

Table 59 consists of 700 combinations of the long-chained and short-chained carboxylic acids as described above in Table 1, the short-chained carboxylic acid being present as a yttrium salt and carboxylic acids with several acid functions, all the acid functions being present in salt form. Polybutyl methacrylate is in each case employed as the binder.

After removal of the organic auxiliary substances, the specific surface area, measured by the BET method, of the finished powder from which the binder has been removed is 3 m²/g to 70 m²/g, for example, 7 m²/g to 30 m²/g, or 10 m²/g to 25 m²/g.

The specific surface area, measured herein by the BET method after burning out the organic auxiliary substances, without pressing the powder.

The present invention is hereinafter described in more detail by the following examples. Although all the examples relate to a partially stabilized zirconium oxide with 3 mol % of Y oxide, they can be applied accordingly to any fully or partially stabilized or non-stabilized with zirconium oxide with any content of monoclinic phase, including in a mixture with other oxides. The theoretical density of the present partially stabilized zirconium oxide with 3 mol % of yttrium oxide (Y₂O₃) is 6.10 g/cm³.

### Example 1

### Comparative—Not Inventive

Two commercially available, partially stabilized and formulated zirconium oxide powders with 3 mol % of Y oxide were analyzed in the KZK powder tester. These are the types TZ 3YSB (manufacturer: Tosoh, Japan) and KZ-3YF (SD), type E AC (manufacturer: KCM, Japan). The results are summarized in the following tables:

Green density established: 3.15 g/cm³

| | Powder Type | |
|---|---|---|
| | TZ 3YSB | KZ-3YF (SD) |
| | Batch S307722B | Type AK, Batch 1608 |
| Actual compact density | 2.96 | 3.05 |
| (g/cm³) | | |
| Axial elastic relaxation (%) | 4.4 | 2.3 |
| Radial elastic relaxation (%) | 0.7 | 0.35 |
| Maximum pressing pressure | 151 | 54 |
| (MPa) | | |
| Sliding coefficient | 0.54 | 0.53 |
| Cohesiveness | 0.5 | 0.68 |
| Axial green strength (MPa) | 9 | 4 |
| Radial green strength (MPa) | 10 | 5 |

Green density established: 3.30 g/cm³

| | Powder Type | |
|---|---|---|
| | TZ 3YSB | KZ-3YF (SD) |
| | Batch S307722B | Type AK, Batch 1608 |
| Actual compact density | 3.08 | 3.16 |
| (g/cm³) | | |
| Axial elastic relaxation (%) | 4.9 | 2.0 |
| Radial elastic relaxation (%) | 0.8 | 0.4 |
| Maximum pressing pressure | 224 | 91 |
| (MPa) | | |
| Sliding coefficient | 0.57 | 0.53 |
| Cohesiveness | 0.43 | 0.51 |
| Axial green strength (MPa) | 10.5 | 5.5 |
| Radial green strength (MPa) | 10.4 | 6.4 |

The bulk density and the tap density were also determined with the KZK apparatus, and the ratio obtained. While the TZ 3YSB has a Hausner ratio of 1.11, a value of 1.08 was determined on the KZ 3YF. These values indicate poor compaction properties. The pressing pressures necessary for a compact density of approximately 50% of the theoretical density (=3.05 g/cm³) lie at the limit of that which can be tolerated industrially for TZ 3YSB. The cohesiveness is very significantly below the value of 1, so that industrial processability by means of net shape technology is not expected.

The green machinability was moderate.

Both types of powder are known and conventional raw materials in industry, and are known to achieve strengths above 900 MPa in accordance with ISO 843, but cannot be subjected to green machining in a reliable way and also cannot be processed by means of net shape technology.

### Example 2

### Inventive

The starting substance was a zirconium oxide powder partially stabilized with 3 mol % of Y₂O₃ and with a specific surface area of 16 m²/g and a monoclinic phase content of 42%, dispersed in demineralized water. The following parameters for the particle size distribution was measured on a diluted sample of the suspension by means of laser diffraction (Coulter counter) using the Mie model: D50 70 nm, D90 170 nm. The value for D50 was confirmed with the aid of a field emission electron microscope.

The solids content of the dispersion corresponded to 50 wt. %, and the pH was 9. An aqueous, partly neutralized formulation of a short-chained carboxylic acid with a pH of 5 was added to this dispersion, with vigorous stirring, so that 0.5 kg of carboxylic acid is present per 100 kg of zirconium oxide. During the addition, the suspension was at room temperature. After the addition, stirring was continued and the pH was determined as 9.8. An aqueous, non-neutralized carboxylic acid formulation was then added, so that 2 kg of carboxylic acid are present per 100 kg of zirconium oxide. Stirring was continued and the pH was determined as 8.5. 2.75 kg of an aqueous dispersion of polymethyl metacrylate, as a binder, per 100 kg of zirconium oxide was then added, stirring was continued, the pH was determined as 9 and the resulting formulation was converted into granules by means of spray drying. The following values were obtained with these granules:

| | | |
|---|---|---|
| Green density established (g/cm³) | 3.15 | 3.3 |
| Actual compact density (g/cm³) | 3.03 | 3.15 |
| Axial elastic relaxation (%) | 2.5 | 2.9 |
| Radial elastic relaxation (%) | 0.4 | 0.5 |
| Maximum pressing pressure (MPa) | 76 | 131 |
| Sliding coefficient | 0.61 | 0.58 |
| Cohesiveness | 1.37 | 1.15 |
| Axial green strength (MPa) | 10 | 16 |
| Radial green strength (MPa) | 10 | 13 |

The bulk density and the tap density were furthermore determined, and the ratio was determined. A value of 1.24 was determined. This value indicates very good compaction properties. 50% of the theoretical density is already achieved at 76 MPa. The green strengths are about 50% above the values of the comparison sample from Example 1, and the cohesivenesses of more than 1 are sufficient for net shape technology via axial pressing. The green machinability was very good.

Compacts were furthermore produced for the flexural fracture testing in accordance with ISO 843 by axial pressing and cold isostatic post-compaction under 1,950 bar. The sintered bodies (1475° C./5 h) were then ground to dimensions and to required surface quality.

The following values were obtained: density 6.07 g/cm³, 4-point flexural strength 870 MPa.

### Example 3

### Inventive

An aqueous carboxylic acid formulation as described in Example 2 was added to the dispersion of zirconium oxide in water described in Example 2 so that 3 kg of carboxylic acid are present per 100 kg of zirconium oxide. 2.75 kg of polymethyl methacrylate, in the form of an aqueous dispersion, per 100 kg of zirconium oxide were then added and the resulting formulation was converted into granules by means of spray drying. The following values were obtained with these granules:

| | | |
|---|---|---|
| Green density established (g/cm³) | 3.15 | 3.3 |
| Actual compact density (g/cm³) | 3.04 | 3.16 |
| Axial elastic relaxation (%) | 2.3 | 2.7 |
| Radial elastic relaxation (%) | 0.4 | 0.5 |
| Maximum pressing pressure (MPa) | 55 | 100 |
| Sliding coefficient | 0.65 | 0.63 |
| Cohesiveness | 1.66 | 1.1 |
| Axial green strength (MPa) | 8 | 10 |
| Radial green strength (MPa) | 8 | 12 |

The bulk density in accordance with ASTM B329 and the tap density was furthermore determined, and the ratio was obtained. A value of 1.25 was determined. This value indicates good compaction properties. 50% of the theoretical density is already reached at 55 MPa. The cohesiveness is very high, but the green strength is poorer compared with Example 2. The sliding coefficient is comparatively high.

Compacts were furthermore produced for the flexural fracture testing in accordance with ISO 843, as described in Example 2. After thermal removal of the binder and sintering at 1475° C. for 5 h, the following values were obtained: density 6.08 g/cm³, 4-point flexural strength 804 MPa.

### Example 4

### Inventive

The dispersion of zirconium oxide described in Example 2 and 3 was prepared analogously, but without the carboxylic acid formulation, 1 kg of a phenoxyalcohol surfactant as conventional in industry was used instead. The following values were obtained with the granules obtained in this way:

| | | |
|---|---|---|
| Green density established (g/cm³) | 3.15 | 3.30 |
| Actual compact density (g/cm³) | 3.01 | 3.15 |
| Axial elastic relaxation (%) | 3 | 3.2 |
| Radial elastic relaxation (%) | 0.6 | 0.7 |
| Maximum pressing pressure (MPa) | 178 | 263 |
| Sliding coefficient | 0.56 | 0.58 |
| Cohesiveness | 1.07 | 1.38 |
| Axial green strength (MPa) | 21 | 38 |
| Radial green strength (MPa) | 23 | 30 |

The Hausner ratio was 1.31. However, very high pressing pressures are necessary to achieve 50% of the theoretical density (>178 MPa). The cohesiveness and the green workability were very good.

Compacts were furthermore produced for the flexural fracture testing in accordance with ISO 843 by cold isostatic pressing under 1,950 bar. After removal of the binder by means of heat and sintering at 1475° C. for 5 h, the following values were obtained: density 6.08, 4-point flexural strength 848 MPa.

### Example 5

### Partly Inventive

For the purpose of ascertaining the influence of the compaction properties on the residual porosity and the strength, axially pressed compacts were produced and subjected to cold isostatic post-compaction under only 1,500 bar (instead of 1,950 bar). The lower pressing pressure leads to a lower green density and therefore to a lower sintered density. This indicates how sensitively a powder reacts to the actual pressing pressure, which indeed can vary locally within a relatively large compact and can then lead to pores. Sintering was carried out at 1475° C. for 5 h, the density was then determined, the bodies were ground to dimensions (hard machining), the number of pores on 45×50 mm were determined according to size classes and the strength was determined in accordance with ISO 843. The following table shows the results:

| | Example 2 | Example 3 | Example 4 |
|---|---|---|---|
| Compact density | 3.24 | 3.32 | 3.13 |
| Sintered density | 6.05 | 6.07 | 6.03 |
| 4-point flexural fracture strength | 837 | 645 | 705 |
| Number of pores 30 to 60 μm | 2 | 7 | 4 |
| Number of pores 60 to 100 μm | 2 | 3 | 6 |
| Number of pores >100 μm | 0 | 1 | 2 |

The results of Examples 2 and 5 show the balance of the formulation of Example 2 with respect to processability and strength of the sintered body. The formulation of Examples 3 and 4 show a too low strength, and Example 4 furthermore shows macropores and the lowest sintered density.

The results of Examples 1 to 5 show in direct comparison that the formulation according to the present invention, when the ratio of binder to carboxylic acid is correctly matched, lead to a zirconium oxide of optimum formulation, both the residual porosity, strength and residual pore content in the sintered part and all the parameters which are relevant for the processability of the powder being balanced and optimum. The results can be applied to other zirconium oxide powders if the specific surface area thereof is taken into consideration. In practice, it will therefore always be necessary to determine the optimum content of carboxylic acid by experimentation. Typical contents lie between 0.1 and 5 percent by weight, for example, between 0.5 and 4% by weight.

A long-chained and a short-chained carboxylic acid are employed in the corresponding amounts as carboxylic acid formulations. The long-chained carboxylic acid is employed as the free acid, and the short-chained carboxylic acid is employed as the ammonium salt, potassium salt or free acid. The binders are likewise given, and these are added in the form of an aqueous dispersion or solution. Particular combinations are given in the following table:

| | | Short-chained | | Short-chained |
|---|---|---|---|---|
| | | carboxylic | Long-chained | carboxylic |
| No. | Binder | acid | carboxylic acid | acid employed as |
| 1 | polyvinyl alcohol | formic acid | montanic acid | free acid |
| 2 | polyvinyl alcohol | formic acid | montanic acid | ammonium salt |
| 3 | polyvinyl alcohol | formic acid | montanic acid | potassium salt |
| 4 | polyvinyl alcohol | formic acid | palmitic acid | free acid |
| 5 | polyvinyl alcohol | formic acid | palmitic acid | ammonium salt |
| 6 | polyvinyl alcohol | formic acid | palmitic acid | potassium salt |
| 7 | polyvinyl alcohol | formic acid | stearic acid | free acid |
| 8 | polyvinyl alcohol | formic acid | stearic acid | ammonium salt |
| 9 | polyvinyl alcohol | formic acid | stearic acid | potassium salt |
| 10 | polyvinyl alcohol | ascorbic acid | montanic acid | free acid |
| 11 | polyvinyl alcohol | ascorbic acid | montanic acid | ammonium salt |
| 12 | polyvinyl alcohol | ascorbic acid | montanic acid | potassium salt |
| 13 | polyvinyl alcohol | ascorbic acid | palmitic acid | free acid |
| 14 | polyvinyl alcohol | ascorbic acid | palmitic acid | ammonium salt |
| 15 | polyvinyl alcohol | ascorbic acid | palmitic acid | potassium salt |
| 16 | polyvinyl alcohol | ascorbic acid | stearic acid | free acid |
| 17 | polyvinyl alcohol | ascorbic acid | stearic acid | ammonium salt |
| 18 | polyvinyl alcohol | ascorbic acid | stearic acid | potassium salt |
| 19 | polyvinyl alcohol | acetic acid | montanic acid | free acid |
| 20 | polyvinyl alcohol | acetic acid | montanic acid | ammonium salt |
| 21 | polyvinyl alcohol | acetic acid | montanic acid | potassium salt |
| 22 | polyvinyl alcohol | acetic acid | palmitic acid | free acid |
| 23 | polyvinyl alcohol | acetic acid | palmitic acid | ammonium salt |
| 24 | polyvinyl alcohol | acetic acid | palmitic acid | potassium salt |
| 25 | polyvinyl alcohol | acetic acid | stearic acid | free acid |
| 26 | polyvinyl alcohol | acetic acid | stearic acid | ammonium salt |
| 27 | polyvinyl alcohol | acetic acid | stearic acid | potassium salt |
| 28 | polyvinyl alcohol | fumaric acid | montanic acid | free acid |
| 29 | polyvinyl alcohol | fumaric acid | montanic acid | ammonium salt |
| 30 | polyvinyl alcohol | fumaric acid | montanic acid | potassium salt |
| 31 | polyvinyl alcohol | fumaric acid | palmitic acid | free acid |
| 32 | polyvinyl alcohol | fumaric acid | palmitic acid | ammonium salt |
| 33 | polyvinyl alcohol | fumaric acid | palmitic acid | potassium salt |
| 34 | polyvinyl alcohol | fumaric acid | stearic acid | free acid |
| 35 | polyvinyl alcohol | fumaric acid | stearic acid | ammonium salt |
| 36 | polyvinyl alcohol | fumaric acid | stearic acid | potassium salt |
| 37 | polyvinyl alcohol | maleic acid | montanic acid | free acid |
| 38 | polyvinyl alcohol | maleic acid | montanic acid | ammonium salt |
| 39 | polyvinyl alcohol | maleic acid | montanic acid | potassium salt |
| 40 | polyvinyl alcohol | maleic acid | palmitic acid | free acid |
| 41 | polyvinyl alcohol | maleic acid | palmitic acid | ammonium salt |
| 42 | polyvinyl alcohol | maleic acid | palmitic acid | potassium salt |
| 43 | polyvinyl alcohol | maleic acid | stearic acid | free acid |
| 44 | polyvinyl alcohol | maleic acid | stearic acid | ammonium salt |
| 45 | polyvinyl alcohol | maleic acid | stearic acid | potassium salt |
| 46 | polyvinyl alcohol | malonic acid | montanic acid | free acid |
| 47 | polyvinyl alcohol | malonic acid | montanic acid | ammonium salt |
| 48 | polyvinyl alcohol | malonic acid | montanic acid | potassium salt |
| 49 | polyvinyl alcohol | malonic acid | palmitic acid | free acid |
| 50 | polyvinyl alcohol | malonic acid | palmitic acid | ammonium salt |
| 51 | polyvinyl alcohol | malonic acid | palmitic acid | potassium salt |
| 52 | polyvinyl alcohol | malonic acid | stearic acid | free acid |
| 53 | polyvinyl alcohol | malonic acid | stearic acid | ammonium salt |
| 54 | polyvinyl alcohol | malonic acid | stearic acid | potassium salt |
| 55 | polyvinyl alcohol | lactic acid | montanic acid | free acid |
| 56 | polyvinyl alcohol | lactic acid | montanic acid | ammonium salt |
| 57 | polyvinyl alcohol | lactic acid | montanic acid | potassium salt |
| 58 | polyvinyl alcohol | lactic acid | palmitic acid | free acid |
| 59 | polyvinyl alcohol | lactic acid | palmitic acid | ammonium salt |
| 60 | polyvinyl alcohol | lactic acid | palmitic acid | potassium salt |
| 61 | polyvinyl alcohol | lactic acid | stearic acid | free acid |
| 62 | polyvinyl alcohol | lactic acid | stearic acid | ammonium salt |
| 63 | polyvinyl alcohol | lactic acid | stearic acid | potassium salt |
| 64 | polyvinyl alcohol | oxalic acid | montanic acid | free acid |
| 65 | polyvinyl alcohol | oxalic acid | montanic acid | ammonium salt |
| 66 | polyvinyl alcohol | oxalic acid | montanic acid | potassium salt |
| 67 | polyvinyl alcohol | oxalic acid | palmitic acid | free acid |
| 68 | polyvinyl alcohol | oxalic acid | palmitic acid | ammonium salt |
| 69 | polyvinyl alcohol | oxalic acid | palmitic acid | potassium salt |
| 70 | polyvinyl alcohol | oxalic acid | stearic acid | free acid |
| 71 | polyvinyl alcohol | oxalic acid | stearic acid | ammonium salt |
| 72 | polyvinyl alcohol | oxalic acid | stearic acid | potassium salt |
| 73 | polyvinyl alcohol | tartaric acid | montanic acid | free acid |
| 74 | polyvinyl alcohol | tartaric acid | montanic acid | ammonium salt |
| 75 | polyvinyl alcohol | tartaric acid | montanic acid | potassium salt |
| 76 | polyvinyl alcohol | tartaric acid | palmitic acid | free acid |
| 77 | polyvinyl alcohol | tartaric acid | palmitic acid | ammonium salt |
| 78 | polyvinyl alcohol | tartaric acid | palmitic acid | potassium salt |
| 79 | polyvinyl alcohol | tartaric acid | stearic acid | free acid |
| 80 | polyvinyl alcohol | tartaric acid | stearic acid | ammonium salt |
| 81 | polyvinyl alcohol | tartaric acid | stearic acid | potassium salt |
| 82 | polyvinyl alcohol | citric acid | montanic acid | free acid |
| 83 | polyvinyl alcohol | citric acid | montanic acid | ammonium salt |
| 84 | polyvinyl alcohol | citric acid | montanic acid | potassium salt |
| 85 | polyvinyl alcohol | citric acid | palmitic acid | free acid |
| 86 | polyvinyl alcohol | citric acid | palmitic acid | ammonium salt |
| 87 | polyvinyl alcohol | citric acid | palmitic acid | potassium salt |
| 88 | polyvinyl alcohol | citric acid | stearic acid | free acid |
| 89 | polyvinyl alcohol | citric acid | stearic acid | ammonium salt |
| 90 | polyvinyl alcohol | citric acid | stearic acid | potassium salt |
| 91 | polyvinyl acetate | formic acid | montanic acid | free acid |
| 92 | polyvinyl acetate | formic acid | montanic acid | ammonium salt |
| 93 | polyvinyl acetate | formic acid | montanic acid | potassium salt |
| 94 | polyvinyl acetate | formic acid | palmitic acid | free acid |
| 95 | polyvinyl acetate | formic acid | palmitic acid | ammonium salt |
| 96 | polyvinyl acetate | formic acid | palmitic acid | potassium salt |
| 97 | polyvinyl acetate | formic acid | stearic acid | free acid |
| 98 | polyvinyl acetate | formic acid | stearic acid | ammonium salt |
| 99 | polyvinyl acetate | formic acid | stearic acid | potassium salt |
| 100 | polyvinyl acetate | ascorbic acid | montanic acid | free acid |
| 101 | polyvinyl acetate | ascorbic acid | montanic acid | ammonium salt |
| 102 | polyvinyl acetate | ascorbic acid | montanic acid | potassium salt |
| 103 | polyvinyl acetate | ascorbic acid | palmitic acid | free acid |
| 104 | polyvinyl acetate | ascorbic acid | palmitic acid | ammonium salt |
| 105 | polyvinyl acetate | ascorbic acid | palmitic acid | potassium salt |
| 106 | polyvinyl acetate | ascorbic acid | stearic acid | free acid |
| 107 | polyvinyl acetate | ascorbic acid | stearic acid | ammonium salt |
| 108 | polyvinyl acetate | ascorbic acid | stearic acid | potassium salt |
| 109 | polyvinyl acetate | acetic acid | montanic acid | free acid |
| 110 | polyvinyl acetate | acetic acid | montanic acid | ammonium salt |
| 111 | polyvinyl acetate | acetic acid | montanic acid | potassium salt |
| 112 | polyvinyl acetate | acetic acid | palmitic acid | free acid |
| 113 | polyvinyl acetate | acetic acid | palmitic acid | ammonium salt |
| 114 | polyvinyl acetate | acetic acid | palmitic acid | potassium salt |
| 115 | polyvinyl acetate | acetic acid | stearic acid | free acid |
| 116 | polyvinyl acetate | acetic acid | stearic acid | ammonium salt |
| 117 | polyvinyl acetate | acetic acid | stearic acid | potassium salt |
| 118 | polyvinyl acetate | fumaric acid | montanic acid | free acid |
| 119 | polyvinyl acetate | fumaric acid | montanic acid | ammonium salt |
| 120 | polyvinyl acetate | fumaric acid | montanic acid | potassium salt |
| 121 | polyvinyl acetate | fumaric acid | palmitic acid | free acid |
| 122 | polyvinyl acetate | fumaric acid | palmitic acid | ammonium salt |
| 123 | polyvinyl acetate | fumaric acid | palmitic acid | potassium salt |
| 124 | polyvinyl acetate | fumaric acid | stearic acid | free acid |
| 125 | polyvinyl acetate | fumaric acid | stearic acid | ammonium salt |
| 126 | polyvinyl acetate | fumaric acid | stearic acid | potassium salt |
| 127 | polyvinyl acetate | maleic acid | montanic acid | free acid |
| 128 | polyvinyl acetate | maleic acid | montanic acid | ammonium salt |
| 129 | polyvinyl acetate | maleic acid | montanic acid | potassium salt |
| 130 | polyvinyl acetate | maleic acid | palmitic acid | free acid |
| 131 | polyvinyl acetate | maleic acid | palmitic acid | ammonium salt |
| 132 | polyvinyl acetate | maleic acid | palmitic acid | potassium salt |
| 133 | polyvinyl acetate | maleic acid | stearic acid | free acid |
| 134 | polyvinyl acetate | maleic acid | stearic acid | ammonium salt |
| 135 | polyvinyl acetate | maleic acid | stearic acid | potassium salt |
| 136 | polyvinyl acetate | malonic acid | montanic acid | free acid |
| 137 | polyvinyl acetate | malonic acid | montanic acid | ammonium salt |
| 138 | polyvinyl acetate | malonic acid | montanic acid | potassium salt |
| 139 | polyvinyl acetate | malonic acid | palmitic acid | free acid |
| 140 | polyvinyl acetate | malonic acid | palmitic acid | ammonium salt |
| 141 | polyvinyl acetate | malonic acid | palmitic acid | potassium salt |
| 142 | polyvinyl acetate | malonic acid | stearic acid | free acid |
| 143 | polyvinyl acetate | malonic acid | stearic acid | ammonium salt |
| 144 | polyvinyl acetate | malonic acid | stearic acid | potassium salt |
| 145 | polyvinyl acetate | lactic acid | montanic acid | free acid |
| 146 | polyvinyl acetate | lactic acid | montanic acid | ammonium salt |
| 147 | polyvinyl acetate | lactic acid | montanic acid | potassium salt |
| 148 | polyvinyl acetate | lactic acid | palmitic acid | free acid |
| 149 | polyvinyl acetate | lactic acid | palmitic acid | ammonium salt |
| 150 | polyvinyl acetate | lactic acid | palmitic acid | potassium salt |
| 151 | polyvinyl acetate | lactic acid | stearic acid | free acid |
| 152 | polyvinyl acetate | lactic acid | stearic acid | ammonium salt |
| 153 | polyvinyl acetate | lactic acid | stearic acid | potassium salt |
| 154 | polyvinyl acetate | oxalic acid | montanic acid | free acid |
| 155 | polyvinyl acetate | oxalic acid | montanic acid | ammonium salt |
| 156 | polyvinyl acetate | oxalic acid | montanic acid | potassium salt |
| 157 | polyvinyl acetate | oxalic acid | palmitic acid | free acid |
| 158 | polyvinyl acetate | oxalic acid | palmitic acid | ammonium salt |
| 159 | polyvinyl acetate | oxalic acid | palmitic acid | potassium salt |
| 160 | polyvinyl acetate | oxalic acid | stearic acid | free acid |
| 161 | polyvinyl acetate | oxalic acid | stearic acid | ammonium salt |
| 162 | polyvinyl acetate | oxalic acid | stearic acid | potassium salt |
| 163 | polyvinyl acetate | tartaric acid | montanic acid | free acid |
| 164 | polyvinyl acetate | tartaric acid | montanic acid | ammonium salt |
| 165 | polyvinyl acetate | tartaric acid | montanic acid | potassium salt |
| 166 | polyvinyl acetate | tartaric acid | palmitic acid | free acid |
| 167 | polyvinyl acetate | tartaric acid | palmitic acid | ammonium salt |
| 168 | polyvinyl acetate | tartaric acid | palmitic acid | potassium salt |
| 169 | polyvinyl acetate | tartaric acid | stearic acid | free acid |
| 170 | polyvinyl acetate | tartaric acid | stearic acid | ammonium salt |
| 171 | polyvinyl acetate | tartaric acid | stearic acid | potassium salt |
| 172 | polyvinyl acetate | citric acid | montanic acid | free acid |
| 173 | polyvinyl acetate | citric acid | montanic acid | ammonium salt |
| 174 | polyvinyl acetate | citric acid | montanic acid | potassium salt |
| 175 | polyvinyl acetate | citric acid | palmitic acid | free acid |
| 176 | polyvinyl acetate | citric acid | palmitic acid | ammonium salt |
| 177 | polyvinyl acetate | citric acid | palmitic acid | potassium salt |
| 178 | polyvinyl acetate | citric acid | stearic acid | free acid |
| 179 | polyvinyl acetate | citric acid | stearic acid | ammonium salt |
| 180 | polyvinyl acetate | citric acid | stearic acid | potassium salt |
| 181 | polyvinylimine | formic acid | montanic acid | free acid |
| 182 | polyvinylimine | formic acid | montanic acid | ammonium salt |
| 183 | polyvinylimine | formic acid | montanic acid | potassium salt |
| 184 | polyvinylimine | formic acid | palmitic acid | free acid |
| 185 | polyvinylimine | formic acid | palmitic acid | ammonium salt |
| 186 | polyvinylimine | formic acid | palmitic acid | potassium salt |
| 187 | polyvinylimine | formic acid | stearic acid | free acid |
| 188 | polyvinylimine | formic acid | stearic acid | ammonium salt |
| 189 | polyvinylimine | formic acid | stearic acid | potassium salt |
| 190 | polyvinylimine | ascorbic acid | montanic acid | free acid |
| 191 | polyvinylimine | ascorbic acid | montanic acid | ammonium salt |
| 192 | polyvinylimine | ascorbic acid | montanic acid | potassium salt |
| 193 | polyvinylimine | ascorbic acid | palmitic acid | free acid |
| 194 | polyvinylimine | ascorbic acid | palmitic acid | ammonium salt |
| 195 | polyvinylimine | ascorbic acid | palmitic acid | potassium salt |
| 196 | polyvinylimine | ascorbic acid | stearic acid | free acid |
| 197 | polyvinylimine | ascorbic acid | stearic acid | ammonium salt |
| 198 | polyvinylimine | ascorbic acid | stearic acid | potassium salt |
| 199 | polyvinylimine | acetic acid | montanic acid | free acid |
| 200 | polyvinylimine | acetic acid | montanic acid | ammonium salt |
| 201 | polyvinylimine | acetic acid | montanic acid | potassium salt |
| 202 | polyvinylimine | acetic acid | palmitic acid | free acid |
| 203 | polyvinylimine | acetic acid | palmitic acid | ammonium salt |
| 204 | polyvinylimine | acetic acid | palmitic acid | potassium salt |
| 205 | polyvinylimine | acetic acid | stearic acid | free acid |
| 206 | polyvinylimine | acetic acid | stearic acid | ammonium salt |
| 207 | polyvinylimine | acetic acid | stearic acid | potassium salt |
| 208 | polyvinylimine | fumaric acid | montanic acid | free acid |
| 209 | polyvinylimine | fumaric acid | montanic acid | ammonium salt |
| 210 | polyvinylimine | fumaric acid | montanic acid | potassium salt |
| 211 | polyvinylimine | fumaric acid | palmitic acid | free acid |
| 212 | polyvinylimine | fumaric acid | palmitic acid | ammonium salt |
| 213 | polyvinylimine | fumaric acid | palmitic acid | potassium salt |
| 214 | polyvinylimine | fumaric acid | stearic acid | free acid |
| 215 | polyvinylimine | fumaric acid | stearic acid | ammonium salt |
| 216 | polyvinylimine | fumaric acid | stearic acid | potassium salt |
| 217 | polyvinylimine | maleic acid | montanic acid | free acid |
| 218 | polyvinylimine | maleic acid | montanic acid | ammonium salt |
| 219 | polyvinylimine | maleic acid | montanic acid | potassium salt |
| 220 | polyvinylimine | maleic acid | palmitic acid | free acid |
| 221 | polyvinylimine | maleic acid | palmitic acid | ammonium salt |
| 222 | polyvinylimine | maleic acid | palmitic acid | potassium salt |
| 223 | polyvinylimine | maleic acid | stearic acid | free acid |
| 224 | polyvinylimine | maleic acid | stearic acid | ammonium salt |
| 225 | polyvinylimine | maleic acid | stearic acid | potassium salt |
| 226 | polyvinylimine | malonic acid | montanic acid | free acid |
| 227 | polyvinylimine | malonic acid | montanic acid | ammonium salt |
| 228 | polyvinylimine | malonic acid | montanic acid | potassium salt |
| 229 | polyvinylimine | malonic acid | palmitic acid | free acid |
| 230 | polyvinylimine | malonic acid | palmitic acid | ammonium salt |
| 231 | polyvinylimine | malonic acid | palmitic acid | potassium salt |
| 232 | polyvinylimine | malonic acid | stearic acid | free acid |
| 233 | polyvinylimine | malonic acid | stearic acid | ammonium salt |
| 234 | polyvinylimine | malonic acid | stearic acid | potassium salt |
| 235 | polyvinylimine | lactic acid | montanic acid | free acid |
| 236 | polyvinylimine | lactic acid | montanic acid | ammonium salt |
| 237 | polyvinylimine | lactic acid | montanic acid | potassium salt |
| 238 | polyvinylimine | lactic acid | palmitic acid | free acid |
| 239 | polyvinylimine | lactic acid | palmitic acid | ammonium salt |
| 240 | polyvinylimine | lactic acid | palmitic acid | potassium salt |
| 241 | polyvinylimine | lactic acid | stearic acid | free acid |
| 242 | polyvinylimine | lactic acid | stearic acid | ammonium salt |
| 243 | polyvinylimine | lactic acid | stearic acid | potassium salt |
| 244 | polyvinylimine | oxalic acid | montanic acid | free acid |
| 245 | polyvinylimine | oxalic acid | montanic acid | ammonium salt |
| 246 | polyvinylimine | oxalic acid | montanic acid | potassium salt |
| 247 | polyvinylimine | oxalic acid | palmitic acid | free acid |
| 248 | polyvinylimine | oxalic acid | palmitic acid | ammonium salt |
| 249 | polyvinylimine | oxalic acid | palmitic acid | potassium salt |
| 250 | polyvinylimine | oxalic acid | stearic acid | free acid |
| 251 | polyvinylimine | oxalic acid | stearic acid | ammonium salt |
| 252 | polyvinylimine | oxalic acid | stearic acid | potassium salt |
| 253 | polyvinylimine | tartaric acid | montanic acid | free acid |
| 254 | polyvinylimine | tartaric acid | montanic acid | ammonium salt |
| 255 | polyvinylimine | tartaric acid | montanic acid | potassium salt |
| 256 | polyvinylimine | tartaric acid | palmitic acid | free acid |
| 257 | polyvinylimine | tartaric acid | palmitic acid | ammonium salt |
| 258 | polyvinylimine | tartaric acid | palmitic acid | potassium salt |
| 259 | polyvinylimine | tartaric acid | stearic acid | free acid |
| 260 | polyvinylimine | tartaric acid | stearic acid | ammonium salt |
| 261 | polyvinylimine | tartaric acid | stearic acid | potassium salt |
| 262 | polyvinylimine | citric acid | montanic acid | free acid |
| 263 | polyvinylimine | citric acid | montanic acid | ammonium salt |
| 264 | polyvinylimine | citric acid | montanic acid | potassium salt |
| 265 | polyvinylimine | citric acid | palmitic acid | free acid |
| 266 | polyvinylimine | citric acid | palmitic acid | ammonium salt |
| 267 | polyvinylimine | citric acid | palmitic acid | potassium salt |
| 268 | polyvinylimine | citric acid | stearic acid | free acid |
| 269 | polyvinylimine | citric acid | stearic acid | ammonium salt |
| 270 | polyvinylimine | citric acid | stearic acid | potassium salt |
| 271 | polybutyl acrylate- | formic acid | montanic acid | free acid |
| | polymethyl methacrylate blend | | | |
| 272 | polybutyl acrylate- | formic acid | montanic acid | ammonium salt |
| | polymethyl methacrylate | | | |
| | blend | | | |
| 273 | polybutyl acrylate- | formic acid | montanic acid | potassium salt |
| | polymethyl methacrylate | | | |
| | blend | | | |
| 274 | polybutyl acrylate- | formic acid | palmitic acid | free acid |
| | polymethyl methacrylate | | | |
| | blend | | | |
| 275 | polybutyl acrylate- | formic acid | palmitic acid | ammonium salt |
| | polymethyl methacrylate blend | | | |
| 276 | polybutyl acrylate- | formic acid | palmitic acid | potassium salt |
| | polymethyl methacrylate | | | |
| | blend | | | |
| 277 | polybutyl acrylate- | formic acid | stearic acid | free acid |
| | polymethyl methacrylate | | | |
| | blend | | | |
| 278 | polybutyl acrylate- | formic acid | stearic acid | ammonium salt |
| | polymethyl methacrylate | | | |
| | blend | | | |
| 279 | polybutyl acrylate- | formic acid | stearic acid | potassium salt |
| | polymethyl methacrylate | | | |
| | blend | | | |
| 280 | polybutyl acrylate- | ascorbic acid | montanic acid | free acid |
| | polymethyl methacrylate | | | |
| | blend | | | |
| 281 | polybutyl acrylate- | ascorbic acid | montanic acid | ammonium salt |
| | polymethyl methacrylate | | | |
| | blend | | | |
| 282 | polybutyl acrylate- | ascorbic acid | montanic acid | potassium salt |
| | polymethyl methacrylate | | | |
| | blend | | | |
| 283 | polybutyl acrylate- | ascorbic acid | palmitic acid | free acid |
| | polymethyl methacrylate | | | |
| | blend | | | |
| 284 | polybutyl acrylate- | ascorbic acid | palmitic acid | ammonium salt |
| | polymethyl methacrylate | | | |
| | blend | | | |
| 285 | polybutyl acrylate- | ascorbic acid | palmitic acid | potassium salt |
| | polymethyl methacrylate | | | |
| | blend | | | |
| 286 | polybutyl acrylate- | ascorbic acid | stearic acid | free acid |
| | polymethyl methacrylate | | | |
| | blend | | | |
| 287 | polybutyl acrylate- | ascorbic acid | stearic acid | ammonium salt |
| | polymethyl methacrylate | | | |
| | blend | | | |
| 288 | polybutyl acrylate- | ascorbic acid | stearic acid | potassium salt |
| | polymethyl methacrylate | | | |
| | blend | | | |
| 289 | polybutyl acrylate- | acetic acid | montanic acid | free acid |
| | polymethyl methacrylate | | | |
| | blend | | | |
| 290 | polybutyl acrylate- | acetic acid | montanic acid | ammonium salt |
| | polymethyl methacrylate blend | | | |
| 291 | polybutyl acrylate- | acetic acid | montanic acid | potassium salt |
| | polymethyl methacrylate | | | |
| | blend | | | |
| 292 | polybutyl acrylate- | acetic acid | palmitic acid | free acid |
| | polymethyl methacrylate | | | |
| | blend | | | |
| 293 | polybutyl acrylate- | acetic acid | palmitic acid | ammonium salt |
| | polymethyl methacrylate | | | |
| | blend | | | |
| 294 | polybutyl acrylate- | acetic acid | palmitic acid | potassium salt |
| | polymethyl methacrylate | | | |
| | blend | | | |
| 295 | polybutyl acrylate- | acetic acid | stearic acid | free acid |
| | polymethyl methacrylate | | | |
| | blend | | | |
| 296 | polybutyl acrylate- | acetic acid | stearic acid | ammonium salt |
| | polymethyl methacrylate | | | |
| | blend | | | |
| 297 | polybutyl acrylate- | acetic acid | stearic acid | potassium salt |
| | polymethyl methacrylate | | | |
| | blend | | | |
| 298 | polybutyl acrylate- | fumaric acid | montanic acid | free acid |
| | polymethyl methacrylate | | | |
| | blend | | | |
| 299 | polybutyl acrylate- | fumaric acid | montanic acid | ammonium salt |
| | polymethyl methacrylate | | | |
| | blend | | | |
| 300 | polybutyl acrylate- | fumaric acid | montanic acid | potassium salt |
| | polymethyl methacrylate | | | |
| | blend | | | |
| 301 | polybutyl acrylate- | fumaric acid | palmitic acid | free acid |
| | polymethyl methacrylate | | | |
| | blend | | | |
| 302 | polybutyl acrylate- | fumaric acid | palmitic acid | ammonium salt |
| | polymethyl methacrylate | | | |
| | blend | | | |
| 303 | polybutyl acrylate- | fumaric acid | palmitic acid | potassium salt |
| | polymethyl methacrylate | | | |
| | blend | | | |
| 304 | polybutyl acrylate- | fumaric acid | stearic acid | free acid |
| | polymethyl methacrylate | | | |
| | blend | | | |
| 305 | polybutyl acrylate- | fumaric acid | stearic acid | ammonium salt |
| | polymethyl methacrylate | | | |
| | blend | | | |
| 306 | polybutyl acrylate- | fumaric acid | stearic acid | potassium salt |
| | polymethyl methacrylate | | | |
| | blend | | | |
| 307 | polybutyl acrylate- | maleic acid | montanic acid | free acid |
| | polymethyl methacrylate | | | |
| | blend | | | |
| 308 | polybutyl acrylate- | maleic acid | montanic acid | ammonium salt |
| | polymethyl methacrylate | | | |
| | blend | | | |
| 309 | polybutyl acrylate- | maleic acid | montanic acid | potassium salt |
| | polymethyl methacrylate | | | |
| | blend | | | |
| 310 | polybutyl acrylate- | maleic acid | palmitic acid | free acid |
| | polymethyl methacrylate | | | |
| | blend | | | |
| 311 | polybutyl acrylate- | maleic acid | palmitic acid | ammonium salt |
| | polymethyl methacrylate blend | | | |
| 312 | polybutyl acrylate- | maleic acid | palmitic acid | potassium salt |
| | polymethyl methacrylate | | | |
| | blend | | | |
| 313 | polybutyl acrylate- | maleic acid | stearic acid | free acid |
| | polymethyl methacrylate | | | |
| | blend | | | |
| 314 | polybutyl acrylate- | maleic acid | stearic acid | ammonium salt |
| | polymethyl methacrylate | | | |
| | blend | | | |
| 315 | polybutyl acrylate- | maleic acid | stearic acid | potassium salt |
| | polymethyl methacrylate | | | |
| | blend | | | |
| 316 | polybutyl acrylate- | malonic acid | montanic acid | free acid |
| | polymethyl methacrylate | | | |
| | blend | | | |
| 317 | polybutyl acrylate- | malonic acid | montanic acid | ammonium salt |
| | polymethyl methacrylate | | | |
| | blend | | | |
| 318 | polybutyl acrylate- | malonic acid | montanic acid | potassium salt |
| | polymethyl methacrylate | | | |
| | blend | | | |
| 319 | polybutyl acrylate- | malonic acid | palmitic acid | free acid |
| | polymethyl methacrylate | | | |
| | blend | | | |
| 320 | polybutyl acrylate- | malonic acid | palmitic acid | ammonium salt |
| | polymethyl methacrylate | | | |
| | blend | | | |
| 321 | polybutyl acrylate- | malonic acid | palmitic acid | potassium salt |
| | polymethyl methacrylate | | | |
| | blend | | | |
| 322 | polybutyl acrylate- | malonic acid | stearic acid | free acid |
| | polymethyl methacrylate | | | |
| | blend | | | |
| 323 | polybutyl acrylate- | malonic acid | stearic acid | ammonium salt |
| | polymethyl methacrylate | | | |
| | blend | | | |
| 324 | polybutyl acrylate- | malonic acid | stearic acid | potassium salt |
| | polymethyl methacrylate | | | |
| | blend | | | |
| 325 | polybutyl acrylate- | lactic acid | montanic acid | free acid |
| | polymethyl methacrylate | | | |
| | blend | | | |
| 326 | polybutyl acrylate- | lactic acid | montanic acid | ammonium salt |
| | polymethyl methacrylate | | | |
| | blend | | | |
| 327 | polybutyl acrylate- | lactic acid | montanic acid | potassium salt |
| | polymethyl methacrylate | | | |
| | blend | | | |
| 328 | polybutyl acrylate- | lactic acid | palmitic acid | free acid |
| | polymethyl methacrylate | | | |
| | blend | | | |
| 329 | polybutyl acrylate- | lactic acid | palmitic acid | ammonium salt |
| | polymethyl methacrylate | | | |
| | blend | | | |
| 330 | polybutyl acrylate- | lactic acid | palmitic acid | potassium salt |
| | polymethyl methacrylate | | | |
| | blend | | | |
| 331 | polybutyl acrylate- | lactic acid | stearic acid | free acid |
| | polymethyl methacrylate | | | |
| | blend | | | |
| 332 | polybutyl acrylate- | lactic acid | stearic acid | ammonium salt |
| | polymethyl methacrylate | | | |
| | blend | | | |
| 333 | polybutyl acrylate- | lactic acid | stearic acid | potassium salt |
| | polymethyl methacrylate | | | |
| | blend | | | |
| 334 | polybutyl acrylate- | oxalic acid | montanic acid | free acid |
| | polymethyl methacrylate | | | |
| | blend | | | |
| 335 | polybutyl acrylate- | oxalic acid | montanic acid | ammonium salt |
| | polymethyl methacrylate | | | |
| | blend | | | |
| 336 | polybutyl acrylate- | oxalic acid | montanic acid | potassium salt |
| | polymethyl methacrylate | | | |
| | blend | | | |
| 337 | polybutyl acrylate- | oxalic acid | palmitic acid | free acid |
| | polymethyl methacrylate | | | |
| | blend | | | |
| 338 | polybutyl acrylate- | oxalic acid | palmitic acid | ammonium salt |
| | polymethyl methacrylate | | | |
| | blend | | | |
| 339 | polybutyl acrylate- | oxalic acid | palmitic acid | potassium salt |
| | polymethyl methacrylate | | | |
| | blend | | | |
| 340 | polybutyl acrylate- | oxalic acid | stearic acid | free acid |
| | polymethyl methacrylate | | | |
| | blend | | | |
| 341 | polybutyl acrylate- | oxalic acid | stearic acid | ammonium salt |
| | polymethyl methacrylate | | | |
| | blend | | | |
| 342 | polybutyl acrylate- | oxalic acid | stearic acid | potassium salt |
| | polymethyl methacrylate | | | |
| | blend | | | |
| 343 | polybutyl acrylate- | tartaric acid | montanic acid | free acid |
| | polymethyl methacrylate | | | |
| | blend | | | |
| 344 | polybutyl acrylate- | tartaric acid | montanic acid | ammonium salt |
| | polymethyl methacrylate | | | |
| | blend | | | |
| 345 | polybutyl acrylate- | tartaric acid | montanic acid | potassium salt |
| | polymethyl methacrylate | | | |
| | blend | | | |
| 346 | polybutyl acrylate- | tartaric acid | palmitic acid | free acid |
| | polymethyl methacrylate | | | |
| | blend | | | |
| 347 | polybutyl acrylate- | tartaric acid | palmitic acid | ammonium salt |
| | polymethyl methacrylate | | | |
| | blend | | | |
| 348 | polybutyl acrylate- | tartaric acid | palmitic acid | potassium salt |
| | polymethyl methacrylate | | | |
| | blend | | | |
| 349 | polybutyl acrylate- | tartaric acid | stearic acid | free acid |
| | polymethyl methacrylate | | | |
| | blend | | | |
| 350 | polybutyl acrylate- | tartaric acid | stearic acid | ammonium salt |
| | polymethyl methacrylate | | | |
| | blend | | | |
| 351 | polybutyl acrylate- | tartaric acid | stearic acid | potassium salt |
| | polymethyl methacrylate | | | |
| | blend | | | |
| 352 | polybutyl acrylate- | citric acid | montanic acid | free acid |
| | polymethyl methacrylate | | | |
| | blend | | | |
| 353 | polybutyl acrylate- | citric acid | montanic acid | ammonium salt |
| | polymethyl methacrylate | | | |
| | blend | | | |
| 354 | polybutyl acrylate- | citric acid | montanic acid | potassium salt |
| | polymethyl methacrylate | | | |
| | blend | | | |
| 355 | polybutyl acrylate- | citric acid | palmitic acid | free acid |
| | polymethyl methacrylate | | | |
| | blend | | | |
| 356 | polybutyl acrylate- | citric acid | palmitic acid | ammonium salt |
| | polymethyl methacrylate | | | |
| | blend | | | |
| 357 | polybutyl acrylate- | citric acid | palmitic acid | potassium salt |
| | polymethyl methacrylate | | | |
| | blend | | | |
| 358 | polybutyl acrylate- | citric acid | stearic acid | free acid |
| | polymethyl methacrylate | | | |
| | blend | | | |
| 359 | polybutyl acrylate- | citric acid | stearic acid | ammonium salt |
| | polymethyl methacrylate | | | |
| | blend | | | |
| 360 | polybutyl acrylate- | citric acid | stearic acid | potassium salt |
| | polymethyl methacrylate | | | |
| | blend | | | |
| 361 | polymethyl methacrylate- | formic acid | montanic acid | free acid |
| | polymethyl acrylate | | | |
| | blend | | | |
| 362 | polymethyl methacrylate- | formic acid | montanic acid | ammonium salt |
| | polymethyl acrylate | | | |
| | blend | | | |
| 363 | polymethyl methacrylate- | formic acid | montanic acid | potassium salt |
| | polymethyl acrylate | | | |
| | blend | | | |
| 364 | polymethyl methacrylate- | formic acid | palmitic acid | free acid |
| | polymethyl acrylate | | | |
| | blend | | | |
| 365 | polymethyl methacrylate- | formic acid | palmitic acid | ammonium salt |
| | polymethyl acrylate | | | |
| | blend | | | |
| 366 | polymethyl methacrylate- | formic acid | palmitic acid | potassium salt |
| | polymethyl acrylate | | | |
| | blend | | | |
| 367 | polymethyl methacrylate- | formic acid | stearic acid | free acid |
| | polymethyl acrylate | | | |
| | blend | | | |
| 368 | polymethyl methacrylate- | formic acid | stearic acid | ammonium salt |
| | polymethyl acrylate | | | |
| | blend | | | |
| 369 | polymethyl methacrylate- | formic acid | stearic acid | potassium salt |
| | polymethyl acrylate | | | |
| | blend | | | |
| 370 | polymethyl methacrylate- | ascorbic acid | montanic acid | free acid |
| | polymethyl acrylate | | | |
| | blend | | | |
| 371 | polymethyl methacrylate- | ascorbic acid | montanic acid | ammonium salt |
| | polymethyl acrylate | | | |
| | blend | | | |
| 372 | polymethyl methacrylate- | ascorbic acid | montanic acid | potassium salt |
| | polymethyl acrylate | | | |
| | blend | | | |
| 373 | polymethyl methacrylate- | ascorbic acid | palmitic acid | free acid |
| | polymethyl acrylate | | | |
| | blend | | | |
| 374 | polymethyl methacrylate- | ascorbic acid | palmitic acid | ammonium salt |
| | polymethyl acrylate | | | |
| | blend | | | |
| 375 | polymethyl methacrylate- | ascorbic acid | palmitic acid | potassium salt |
| | polymethyl acrylate | | | |
| | blend | | | |
| 376 | polymethyl methacrylate- | ascorbic acid | stearic acid | free acid |
| | polymethyl acrylate | | | |
| | blend | | | |
| 377 | polymethyl methacrylate- | ascorbic acid | stearic acid | ammonium salt |
| | polymethyl acrylate | | | |
| | blend | | | |
| 378 | polymethyl methacrylate- | ascorbic acid | stearic acid | potassium salt |
| | polymethyl acrylate | | | |
| | blend | | | |
| 379 | polymethyl methacrylate- | acetic acid | montanic acid | free acid |
| | polymethyl acrylate | | | |
| | blend | | | |
| 380 | polymethyl methacrylate- | acetic acid | montanic acid | ammonium salt |
| | polymethyl acrylate | | | |
| | blend | | | |
| 381 | polymethyl methacrylate- | acetic acid | montanic acid | potassium salt |
| | polymethyl acrylate | | | |
| | blend | | | |
| 382 | polymethyl methacrylate- | acetic acid | palmitic acid | free acid |
| | polymethyl acrylate | | | |
| | blend | | | |
| 383 | polymethyl methacrylate- | acetic acid | palmitic acid | ammonium salt |
| | polymethyl acrylate | | | |
| | blend | | | |
| 384 | polymethyl methacrylate- | acetic acid | palmitic acid | potassium salt |
| | polymethyl acrylate | | | |
| | blend | | | |
| 385 | polymethyl methacrylate- | acetic acid | stearic acid | free acid |
| | polymethyl acrylate | | | |
| | blend | | | |
| 386 | polymethyl methacrylate- | acetic acid | stearic acid | ammonium salt |
| | polymethyl acrylate | | | |
| | blend | | | |
| 387 | polymethyl methacrylate- | acetic acid | stearic acid | potassium salt |
| | polymethyl acrylate | | | |
| | blend | | | |
| 388 | polymethyl methacrylate- | fumaric acid | montanic acid | free acid |
| | polymethyl acrylate | | | |
| | blend | | | |
| 389 | polymethyl methacrylate- | fumaric acid | montanic acid | ammonium salt |
| | polymethyl acrylate | | | |
| | blend | | | |
| 390 | polymethyl methacrylate- | fumaric acid | montanic acid | potassium salt |
| | polymethyl acrylate | | | |
| | blend | | | |
| 391 | polymethyl methacrylate- | fumaric acid | palmitic acid | free acid |
| | polymethyl acrylate | | | |
| | blend | | | |
| 392 | polymethyl methacrylate- | fumaric acid | palmitic acid | ammonium salt |
| | polymethyl acrylate | | | |
| | blend | | | |
| 393 | polymethyl methacrylate- | fumaric acid | palmitic acid | potassium salt |
| | polymethyl acrylate | | | |
| | blend | | | |
| 394 | polymethyl methacrylate- | fumaric acid | stearic acid | free acid |
| | polymethyl acrylate | | | |
| | blend | | | |
| 395 | polymethyl methacrylate- | fumaric acid | stearic acid | ammonium salt |
| | polymethyl acrylate | | | |
| | blend | | | |
| 396 | polymethyl methacrylate- | fumaric acid | stearic acid | potassium salt |
| | polymethyl acrylate | | | |
| | blend | | | |
| 397 | polymethyl methacrylate- | maleic acid | montanic acid | free acid |
| | polymethyl acrylate | | | |
| | blend | | | |
| 398 | polymethyl methacrylate- | maleic acid | montanic acid | ammonium salt |
| | polymethyl acrylate | | | |
| | blend | | | |
| 399 | polymethyl methacrylate- | maleic acid | montanic acid | potassium salt |
| | polymethyl acrylate | | | |
| | blend | | | |
| 400 | polymethyl methacrylate- | maleic acid | palmitic acid | free acid |
| | polymethyl acrylate | | | |
| | blend | | | |
| 401 | polymethyl methacrylate- | maleic acid | palmitic acid | ammonium salt |
| | polymethyl acrylate | | | |
| | blend | | | |
| 402 | polymethyl methacrylate- | maleic acid | palmitic acid | potassium salt |
| | polymethyl acrylate | | | |
| | blend | | | |
| 403 | polymethyl methacrylate- | maleic acid | stearic acid | free acid |
| | polymethyl acrylate | | | |
| | blend | | | |
| 404 | polymethyl methacrylate- | maleic acid | stearic acid | ammonium salt |
| | polymethyl acrylate | | | |
| | blend | | | |
| 405 | polymethyl methacrylate- | maleic acid | stearic acid | potassium salt |
| | polymethyl acrylate | | | |
| | blend | | | |
| 406 | polymethyl methacrylate- | malonic acid | montanic acid | free acid |
| | polymethyl acrylate | | | |
| | blend | | | |
| 407 | polymethyl methacrylate- | malonic acid | montanic acid | ammonium salt |
| | polymethyl acrylate | | | |
| | blend | | | |
| 408 | polymethyl methacrylate- | malonic acid | montanic acid | potassium salt |
| | polymethyl acrylate | | | |
| | blend | | | |
| 409 | polymethyl methacrylate- | malonic acid | palmitic acid | free acid |
| | polymethyl acrylate | | | |
| | blend | | | |
| 410 | polymethyl methacrylate- | malonic acid | palmitic acid | ammonium salt |
| | polymethyl acrylate | | | |
| | blend | | | |
| 411 | polymethyl methacrylate- | malonic acid | palmitic acid | potassium salt |
| | polymethyl acrylate | | | |
| | blend | | | |
| 412 | polymethyl methacrylate- | malonic acid | stearic acid | free acid |
| | polymethyl acrylate | | | |
| | blend | | | |
| 413 | polymethyl methacrylate- | malonic acid | stearic acid | ammonium salt |
| | polymethyl acrylate | | | |
| | blend | | | |
| 414 | polymethyl methacrylate- | malonic acid | stearic acid | potassium salt |
| | polymethyl acrylate | | | |
| | blend | | | |
| 415 | polymethyl methacrylate- | lactic acid | montanic acid | free acid |
| | polymethyl acrylate | | | |
| | blend | | | |
| 416 | polymethyl methacrylate- | lactic acid | montanic acid | ammonium salt |
| | polymethyl acrylate | | | |
| | blend | | | |
| 417 | polymethyl methacrylate- | lactic acid | montanic acid | potassium salt |
| | polymethyl acrylate | | | |
| | blend | | | |
| 418 | polymethyl methacrylate- | lactic acid | palmitic acid | free acid |
| | polymethyl acrylate | | | |
| | blend | | | |
| 419 | polymethyl methacrylate- | lactic acid | palmitic acid | ammonium salt |
| | polymethyl acrylate | | | |
| | blend | | | |
| 420 | polymethyl methacrylate- | lactic acid | palmitic acid | potassium salt |
| | polymethyl acrylate | | | |
| | blend | | | |
| 421 | polymethyl methacrylate- | lactic acid | stearic acid | free acid |
| | polymethyl acrylate | | | |
| | blend | | | |
| 422 | polymethyl methacrylate- | lactic acid | stearic acid | ammonium salt |
| | polymethyl acrylate | | | |
| | blend | | | |
| 423 | polymethyl methacrylate- | lactic acid | stearic acid | potassium salt |
| | polymethyl acrylate | | | |
| | blend | | | |
| 424 | polymethyl methacrylate- | oxalic acid | montanic acid | free acid |
| | polymethyl acrylate | | | |
| | blend | | | |
| 425 | polymethyl methacrylate- | oxalic acid | montanic acid | ammonium salt |
| | polymethyl acrylate | | | |
| | blend | | | |
| 426 | polymethyl methacrylate- | oxalic acid | montanic acid | potassium salt |
| | polymethyl acrylate | | | |
| | blend | | | |
| 427 | polymethyl methacrylate- | oxalic acid | palmitic acid | free acid |
| | polymethyl acrylate | | | |
| | blend | | | |
| 428 | polymethyl methacrylate- | oxalic acid | palmitic acid | ammonium salt |
| | polymethyl acrylate | | | |
| | blend | | | |
| 429 | polymethyl methacrylate- | oxalic acid | palmitic acid | potassium salt |
| | polymethyl acrylate | | | |
| | blend | | | |
| 430 | polymethyl methacrylate- | oxalic acid | stearic acid | free acid |
| | polymethyl acrylate | | | |
| | blend | | | |
| 431 | polymethyl methacrylate- | oxalic acid | stearic acid | ammonium salt |
| | polymethyl acrylate | | | |
| | blend | | | |
| 432 | polymethyl methacrylate- | oxalic acid | stearic acid | potassium salt |
| | polymethyl acrylate | | | |
| | blend | | | |
| 433 | polymethyl methacrylate- | tartaric acid | montanic acid | free acid |
| | polymethyl acrylate | | | |
| | blend | | | |
| 434 | polymethyl methacrylate- | tartaric acid | montanic acid | ammonium salt |
| | polymethyl acrylate | | | |
| | blend | | | |
| 435 | polymethyl methacrylate- | tartaric acid | montanic acid | potassium salt |
| | polymethyl acrylate | | | |
| | blend | | | |
| 436 | polymethyl methacrylate- | tartaric acid | palmitic acid | free acid |
| | polymethyl acrylate | | | |
| | blend | | | |
| 437 | polymethyl methacrylate- | tartaric acid | palmitic acid | ammonium salt |
| | polymethyl acrylate | | | |
| | blend | | | |
| 438 | polymethyl methacrylate- | tartaric acid | palmitic acid | potassium salt |
| | polymethyl acrylate | | | |
| | blend | | | |
| 439 | polymethyl methacrylate- | tartaric acid | stearic acid | free acid |
| | polymethyl acrylate | | | |
| | blend | | | |
| 440 | polymethyl methacrylate- | tartaric acid | stearic acid | ammonium salt |
| | polymethyl acrylate | | | |
| | blend | | | |
| 441 | polymethyl methacrylate- | tartaric acid | stearic acid | potassium salt |
| | polymethyl acrylate | | | |
| | blend | | | |
| 442 | polymethyl methacrylate- | citric acid | montanic acid | free acid |
| | polymethyl acrylate | | | |
| | blend | | | |
| 443 | polymethyl methacrylate- | citric acid | montanic acid | ammonium salt |
| | polymethyl acrylate | | | |
| | blend | | | |
| 444 | polymethyl methacrylate- | citric acid | montanic acid | potassium salt |
| | polymethyl acrylate | | | |
| | blend | | | |
| 445 | polymethyl methacrylate- | citric acid | palmitic acid | free acid |
| | polymethyl acrylate | | | |
| | blend | | | |
| 446 | polymethyl methacrylate- | citric acid | palmitic acid | ammonium salt |
| | polymethyl acrylate | | | |
| | blend | | | |
| 447 | polymethyl methacrylate- | citric acid | palmitic acid | potassium salt |
| | polymethyl acrylate | | | |
| | blend | | | |
| 448 | polymethyl methacrylate- | citric acid | stearic acid | free acid |
| | polymethyl acrylate | | | |
| | blend | | | |
| 449 | polymethyl methacrylate- | citric acid | stearic acid | ammonium salt |
| | polymethyl acrylate | | | |
| | blend | | | |
| 450 | polymethyl methacrylate- | citric acid | stearic acid | potassium salt |
| | polymethyl acrylate | | | |
| | blend | | | |
| 451 | polyethylene glycol | formic acid | montanic acid | free acid |
| | (molecular weight 3,000) | | | |
| 452 | polyethylene glycol | formic acid | montanic acid | ammonium salt |
| | (molecular weight 3,000) | | | |
| 453 | polyethylene glycol | formic acid | montanic acid | potassium salt |
| | (molecular weight 3,000) | | | |
| 454 | polyethylene glycol | formic acid | palmitic acid | free acid |
| | (molecular weight 3,000) | | | |
| 455 | polyethylene glycol | formic acid | palmitic acid | ammonium salt |
| | (molecular weight 3,000) | | | |
| 456 | polyethylene glycol | formic acid | palmitic acid | potassium salt |
| | (molecular weight 3,000) | | | |
| 457 | polyethylene glycol | formic acid | stearic acid | free acid |
| | (molecular weight 3,000) | | | |
| 458 | polyethylene glycol | formic acid | stearic acid | ammonium salt |
| | (molecular weight 3,000) | | | |
| 459 | polyethylene glycol | formic acid | stearic acid | potassium salt |
| | (molecular weight 3,000) | | | |
| 460 | polyethylene glycol | ascorbic acid | montanic acid | free acid |
| | (molecular weight 3,000) | | | |
| 461 | polyethylene glycol | ascorbic acid | montanic acid | ammonium salt |
| | (molecular weight 3,000) | | | |
| 462 | polyethylene glycol | ascorbic acid | montanic acid | potassium salt |
| | (molecular weight 3,000) | | | |
| 463 | polyethylene glycol | ascorbic acid | palmitic acid | free acid |
| | (molecular weight 3,000) | | | |
| 464 | polyethylene glycol | ascorbic acid | palmitic acid | ammonium salt |
| | (molecular weight 3,000) | | | |
| 465 | polyethylene glycol | ascorbic acid | palmitic acid | potassium salt |
| | (molecular weight 3,000) | | | |
| 466 | polyethylene glycol | ascorbic acid | stearic acid | free acid |
| | (molecular weight 3,000) | | | |
| 467 | polyethylene glycol | ascorbic acid | stearic acid | ammonium salt |
| | (molecular weight 3,000) | | | |
| 468 | polyethylene glycol | ascorbic acid | stearic acid | potassium salt |
| | (molecular weight 3,000) | | | |
| 469 | polyethylene glycol | acetic acid | montanic acid | free acid |
| | (molecular weight 3,000) | | | |
| 470 | polyethylene glycol | acetic acid | montanic acid | ammonium salt |
| | (molecular weight 3,000) | | | |
| 471 | polyethylene glycol | acetic acid | montanic acid | potassium salt |
| | (molecular weight 3,000) | | | |
| 472 | polyethylene glycol | acetic acid | palmitic acid | free acid |
| | (molecular weight 3,000) | | | |
| 473 | polyethylene glycol | acetic acid | palmitic acid | ammonium salt |
| | (molecular weight 3,000) | | | |
| 474 | polyethylene glycol | acetic acid | palmitic acid | potassium salt |
| | (molecular weight 3,000) | | | |
| 475 | polyethylene glycol | acetic acid | stearic acid | free acid |
| | (molecular weight 3,000) | | | |
| 476 | polyethylene glycol | acetic acid | stearic acid | ammonium salt |
| | (molecular weight 3,000) | | | |
| 477 | polyethylene glycol | acetic acid | stearic acid | potassium salt |
| | (molecular weight 3,000) | | | |
| 478 | polyethylene glycol | fumaric acid | montanic acid | free acid |
| | (molecular weight 3,000) | | | |
| 479 | polyethylene glycol | fumaric acid | montanic acid | ammonium salt |
| | (molecular weight 3,000) | | | |
| 480 | polyethylene glycol | fumaric acid | montanic acid | potassium salt |
| | (molecular weight 3,000) | | | |
| 481 | polyethylene glycol | fumaric acid | palmitic acid | free acid |
| | (molecular weight 3,000) | | | |
| 482 | polyethylene glycol | fumaric acid | palmitic acid | ammonium salt |
| | (molecular weight 3,000) | | | |
| 483 | polyethylene glycol | fumaric acid | palmitic acid | potassium salt |
| | (molecular weight 3,000) | | | |
| 484 | polyethylene glycol | fumaric acid | stearic acid | free acid |
| | (molecular weight 3,000) | | | |
| 485 | polyethylene glycol | fumaric acid | stearic acid | ammonium salt |
| | (molecular weight 3,000) | | | |
| 486 | polyethylene glycol | fumaric acid | stearic acid | potassium salt |
| | (molecular weight 3,000) | | | |
| 487 | polyethylene glycol | maleic acid | montanic acid | free acid |
| | (molecular weight 3,000) | | | |
| 488 | polyethylene glycol | maleic acid | montanic acid | ammonium salt |
| | (molecular weight 3,000) | | | |
| 489 | polyethylene glycol | maleic acid | montanic acid | potassium salt |
| | (molecular weight 3,000) | | | |
| 490 | polyethylene glycol | maleic acid | palmitic acid | free acid |
| | (molecular weight 3,000) | | | |
| 491 | polyethylene glycol | maleic acid | palmitic acid | ammonium salt |
| | (molecular weight 3,000) | | | |
| 492 | polyethylene glycol | maleic acid | palmitic acid | potassium salt |
| | (molecular weight 3,000) | | | |
| 493 | polyethylene glycol | maleic acid | stearic acid | free acid |
| | (molecular weight 3,000) | | | |
| 494 | polyethylene glycol | maleic acid | stearic acid | ammonium salt |
| | (molecular weight 3,000) | | | |
| 495 | polyethylene glycol | maleic acid | stearic acid | potassium salt |
| | (molecular weight 3,000) | | | |
| 496 | polyethylene glycol | malonic acid | montanic acid | free acid |
| | (molecular weight 3,000) | | | |
| 497 | polyethylene glycol | malonic acid | montanic acid | ammonium salt |
| | (molecular weight 3,000) | | | |
| 498 | polyethylene glycol | malonic acid | montanic acid | potassium salt |
| | (molecular weight 3,000) | | | |
| 499 | polyethylene glycol | malonic acid | palmitic acid | free acid |
| | (molecular weight 3,000) | | | |
| 500 | polyethylene glycol | malonic acid | palmitic acid | ammonium salt |
| | (molecular weight 3,000) | | | |
| 501 | polyethylene glycol | malonic acid | palmitic acid | potassium salt |
| | (molecular weight 3,000) | | | |
| 502 | polyethylene glycol | malonic acid | stearic acid | free acid |
| | (molecular weight 3,000) | | | |
| 503 | polyethylene glycol | malonic acid | stearic acid | ammonium salt |
| | (molecular weight 3,000) | | | |
| 504 | polyethylene glycol | malonic acid | stearic acid | potassium salt |
| | (molecular weight 3,000) | | | |
| 505 | polyethylene glycol | lactic acid | montanic acid | free acid |
| | (molecular weight 3,000) | | | |
| 506 | polyethylene glycol | lactic acid | montanic acid | ammonium salt |
| | (molecular weight 3,000) | | | |
| 507 | polyethylene glycol | lactic acid | montanic acid | potassium salt |
| | (molecular weight 3,000) | | | |
| 508 | polyethylene glycol | lactic acid | palmitic acid | free acid |
| | (molecular weight 3,000) | | | |
| 509 | polyethylene glycol | lactic acid | palmitic acid | ammonium salt |
| | (molecular weight 3,000) | | | |
| 510 | polyethylene glycol | lactic acid | palmitic acid | potassium salt |
| | (molecular weight 3,000) | | | |
| 511 | polyethylene glycol | lactic acid | stearic acid | free acid |
| | (molecular weight 3,000) | | | |
| 512 | polyethylene glycol | lactic acid | stearic acid | ammonium salt |
| | (molecular weight 3,000) | | | |
| 513 | polyethylene glycol | lactic acid | stearic acid | potassium salt |
| | (molecular weight 3,000) | | | |
| 514 | polyethylene glycol | oxalic acid | montanic acid | free acid |
| | (molecular weight 3,000) | | | |
| 515 | polyethylene glycol | oxalic acid | montanic acid | ammonium salt |
| | (molecular weight 3,000) | | | |
| 516 | polyethylene glycol | oxalic acid | montanic acid | potassium salt |
| | (molecular weight 3,000) | | | |
| 517 | polyethylene glycol | oxalic acid | palmitic acid | free acid |
| | (molecular weight 3,000) | | | |
| 518 | polyethylene glycol | oxalic acid | palmitic acid | ammonium salt |
| | (molecular weight 3,000) | | | |
| 519 | polyethylene glycol | oxalic acid | palmitic acid | potassium salt |
| | (molecular weight 3,000) | | | |
| 520 | polyethylene glycol | oxalic acid | stearic acid | free acid |
| | (molecular weight 3,000) | | | |
| 521 | polyethylene glycol | oxalic acid | stearic acid | ammonium salt |
| | (molecular weight 3,000) | | | |
| 522 | polyethylene glycol | oxalic acid | stearic acid | potassium salt |
| | (molecular weight 3,000) | | | |
| 523 | polyethylene glycol | tartaric acid | montanic acid | free acid |
| | (molecular weight 3,000) | | | |
| 524 | polyethylene glycol | tartaric acid | montanic acid | ammonium salt |
| | (molecular weight 3,000) | | | |
| 525 | polyethylene glycol | tartaric acid | montanic acid | potassium salt |
| | (molecular weight 3,000) | | | |
| 526 | polyethylene glycol | tartaric acid | palmitic acid | free acid |
| | (molecular weight 3,000) | | | |
| 527 | polyethylene glycol | tartaric acid | palmitic acid | ammonium salt |
| | (molecular weight 3,000) | | | |
| 528 | polyethylene glycol | tartaric acid | palmitic acid | potassium salt |
| | (molecular weight 3,000) | | | |
| 529 | polyethylene glycol | tartaric acid | stearic acid | free acid |
| | (molecular weight 3,000) | | | |
| 530 | polyethylene glycol | tartaric acid | stearic acid | ammonium salt |
| | (molecular weight 3,000) | | | |
| 531 | polyethylene glycol | tartaric acid | stearic acid | potassium salt |
| | (molecular weight 3,000) | | | |
| 532 | polyethylene glycol | citric acid | montanic acid | free acid |
| | (molecular weight 3,000) | | | |
| 533 | polyethylene glycol | citric acid | montanic acid | ammonium salt |
| | (molecular weight 3,000) | | | |
| 534 | polyethylene glycol | citric acid | montanic acid | potassium salt |
| | (molecular weight 3,000) | | | |
| 535 | polyethylene glycol | citric acid | palmitic acid | free acid |
| | (molecular weight 3,000) | | | |
| 536 | polyethylene glycol | citric acid | palmitic acid | ammonium salt |
| | (molecular weight 3,000) | | | |
| 537 | polyethylene glycol | citric acid | palmitic acid | potassium salt |
| | (molecular weight 3,000) | | | |
| 538 | polyethylene glycol | citric acid | stearic acid | free acid |
| | (molecular weight 3,000) | | | |
| 539 | polyethylene glycol | citric acid | stearic acid | ammonium salt |
| | (molecular weight 3,000) | | | |
| 540 | polyethylene glycol | citric acid | stearic acid | potassium salt |
| | (molecular weight 3,000) | | | |
| 541 | polyacrylic acid | formic acid | montanic acid | free acid |
| 542 | polyacrylic acid | formic acid | montanic acid | ammonium salt |
| 543 | polyacrylic acid | formic acid | montanic acid | potassium salt |
| 544 | polyacrylic acid | formic acid | palmitic acid | free acid |
| 545 | polyacrylic acid | formic acid | palmitic acid | ammonium salt |
| 546 | polyacrylic acid | formic acid | palmitic acid | potassium salt |
| 547 | polyacrylic acid | formic acid | stearic acid | free acid |
| 548 | polyacrylic acid | formic acid | stearic acid | ammonium salt |
| 549 | polyacrylic acid | formic acid | stearic acid | potassium salt |
| 550 | polyacrylic acid | ascorbic acid | montanic acid | free acid |
| 551 | polyacrylic acid | ascorbic acid | montanic acid | ammonium salt |
| 552 | polyacrylic acid | ascorbic acid | montanic acid | potassium salt |
| 553 | polyacrylic acid | ascorbic acid | palmitic acid | free acid |
| 554 | polyacrylic acid | ascorbic acid | palmitic acid | ammonium salt |
| 555 | polyacrylic acid | ascorbic acid | palmitic acid | potassium salt |
| 556 | polyacrylic acid | ascorbic acid | stearic acid | free acid |
| 557 | polyacrylic acid | ascorbic acid | stearic acid | ammonium salt |
| 558 | polyacrylic acid | ascorbic acid | stearic acid | potassium salt |
| 559 | polyacrylic acid | acetic acid | montanic acid | free acid |
| 560 | polyacrylic acid | acetic acid | montanic acid | ammonium salt |
| 561 | polyacrylic acid | acetic acid | montanic acid | potassium salt |
| 562 | polyacrylic acid | acetic acid | palmitic acid | free acid |
| 563 | polyacrylic acid | acetic acid | palmitic acid | ammonium salt |
| 564 | polyacrylic acid | acetic acid | palmitic acid | potassium salt |
| 565 | polyacrylic acid | acetic acid | stearic acid | free acid |
| 566 | polyacrylic acid | acetic acid | stearic acid | ammonium salt |
| 567 | polyacrylic acid | acetic acid | stearic acid | potassium salt |
| 568 | polyacrylic acid | fumaric acid | montanic acid | free acid |
| 569 | polyacrylic acid | fumaric acid | montanic acid | ammonium salt |
| 570 | polyacrylic acid | fumaric acid | montanic acid | potassium salt |
| 571 | polyacrylic acid | fumaric acid | palmitic acid | free acid |
| 572 | polyacrylic acid | fumaric acid | palmitic acid | ammonium salt |
| 573 | polyacrylic acid | fumaric acid | palmitic acid | potassium salt |
| 574 | polyacrylic acid | fumaric acid | stearic acid | free acid |
| 575 | polyacrylic acid | fumaric acid | stearic acid | ammonium salt |
| 576 | polyacrylic acid | fumaric acid | stearic acid | potassium salt |
| 577 | polyacrylic acid | maleic acid | montanic acid | free acid |
| 578 | polyacrylic acid | maleic acid | montanic acid | ammonium salt |
| 579 | polyacrylic acid | maleic acid | montanic acid | potassium salt |
| 580 | polyacrylic acid | maleic acid | palmitic acid | free acid |
| 581 | polyacrylic acid | maleic acid | palmitic acid | ammonium salt |
| 582 | polyacrylic acid | maleic acid | palmitic acid | potassium salt |
| 583 | polyacrylic acid | maleic acid | stearic acid | free acid |
| 584 | polyacrylic acid | maleic acid | stearic acid | ammonium salt |
| 585 | polyacrylic acid | maleic acid | stearic acid | potassium salt |
| 586 | polyacrylic acid | malonic acid | montanic acid | free acid |
| 587 | polyacrylic acid | malonic acid | montanic acid | ammonium salt |
| 588 | polyacrylic acid | malonic acid | montanic acid | potassium salt |
| 589 | polyacrylic acid | malonic acid | palmitic acid | free acid |
| 590 | polyacrylic acid | malonic acid | palmitic acid | ammonium salt |
| 591 | polyacrylic acid | malonic acid | palmitic acid | potassium salt |
| 592 | polyacrylic acid | malonic acid | stearic acid | free acid |
| 593 | polyacrylic acid | malonic acid | stearic acid | ammonium salt |
| 594 | polyacrylic acid | malonic acid | stearic acid | potassium salt |
| 595 | polyacrylic acid | lactic acid | montanic acid | free acid |
| 596 | polyacrylic acid | lactic acid | montanic acid | ammonium salt |
| 597 | polyacrylic acid | lactic acid | montanic acid | potassium salt |
| 598 | polyacrylic acid | lactic acid | palmitic acid | free acid |
| 599 | polyacrylic acid | lactic acid | palmitic acid | ammonium salt |
| 600 | polyacrylic acid | lactic acid | palmitic acid | potassium salt |
| 601 | polyacrylic acid | lactic acid | stearic acid | free acid |
| 602 | polyacrylic acid | lactic acid | stearic acid | ammonium salt |
| 603 | polyacrylic acid | lactic acid | stearic acid | potassium salt |
| 604 | polyacrylic acid | oxalic acid | montanic acid | free acid |
| 605 | polyacrylic acid | oxalic acid | montanic acid | ammonium salt |
| 606 | polyacrylic acid | oxalic acid | montanic acid | potassium salt |
| 607 | polyacrylic acid | oxalic acid | palmitic acid | free acid |
| 608 | polyacrylic acid | oxalic acid | palmitic acid | ammonium salt |
| 609 | polyacrylic acid | oxalic acid | palmitic acid | potassium salt |
| 610 | polyacrylic acid | oxalic acid | stearic acid | free acid |
| 611 | polyacrylic acid | oxalic acid | stearic acid | ammonium salt |
| 612 | polyacrylic acid | oxalic acid | stearic acid | potassium salt |
| 613 | polyacrylic acid | tartaric acid | montanic acid | free acid |
| 614 | polyacrylic acid | tartaric acid | montanic acid | ammonium salt |
| 615 | polyacrylic acid | tartaric acid | montanic acid | potassium salt |
| 616 | polyacrylic acid | tartaric acid | palmitic acid | free acid |
| 617 | polyacrylic acid | tartaric acid | palmitic acid | ammonium salt |
| 618 | polyacrylic acid | tartaric acid | palmitic acid | potassium salt |
| 619 | polyacrylic acid | tartaric acid | stearic acid | free acid |
| 620 | polyacrylic acid | tartaric acid | stearic acid | ammonium salt |
| 621 | polyacrylic acid | tartaric acid | stearic acid | potassium salt |
| 622 | polyacrylic acid | citric acid | montanic acid | free acid |
| 623 | polyacrylic acid | citric acid | montanic acid | ammonium salt |
| 624 | polyacrylic acid | citric acid | montanic acid | potassium salt |
| 625 | polyacrylic acid | citric acid | palmitic acid | free acid |
| 626 | polyacrylic acid | citric acid | palmitic acid | ammonium salt |
| 627 | polyacrylic acid | citric acid | palmitic acid | potassium salt |
| 628 | polyacrylic acid | citric acid | stearic acid | free acid |
| 629 | polyacrylic acid | citric acid | stearic acid | ammonium salt |
| 630 | polyacrylic acid | citric acid | stearic acid | potassium salt |
| 631 | polymethyl methacrylate | formic acid | montanic acid | free acid |
| 632 | polymethyl methacrylate | formic acid | montanic acid | ammonium salt |
| 633 | polymethyl methacrylate | formic acid | montanic acid | potassium salt |
| 634 | polymethyl methacrylate | formic acid | palmitic acid | free acid |
| 635 | polymethyl methacrylate | formic acid | palmitic acid | ammonium salt |
| 636 | polymethyl methacrylate | formic acid | palmitic acid | potassium salt |
| 637 | polymethyl methacrylate | formic acid | stearic acid | free acid |
| 638 | polymethyl methacrylate | formic acid | stearic acid | ammonium salt |
| 639 | polymethyl methacrylate | formic acid | stearic acid | potassium salt |
| 640 | polymethyl methacrylate | ascorbic acid | montanic acid | free acid |
| 641 | polymethyl methacrylate | ascorbic acid | montanic acid | ammonium salt |
| 642 | polymethyl methacrylate | ascorbic acid | montanic acid | potassium salt |
| 643 | polymethyl methacrylate | ascorbic acid | palmitic acid | free acid |
| 644 | polymethyl methacrylate | ascorbic acid | palmitic acid | ammonium salt |
| 645 | polymethyl methacrylate | ascorbic acid | palmitic acid | potassium salt |
| 646 | polymethyl methacrylate | ascorbic acid | stearic acid | free acid |
| 647 | polymethyl methacrylate | ascorbic acid | stearic acid | ammonium salt |
| 648 | polymethyl methacrylate | ascorbic acid | stearic acid | potassium salt |
| 649 | polymethyl methacrylate | acetic acid | montanic acid | free acid |
| 650 | polymethyl methacrylate | acetic acid | montanic acid | ammonium salt |
| 651 | polymethyl methacrylate | acetic acid | montanic acid | potassium salt |
| 652 | polymethyl methacrylate | acetic acid | palmitic acid | free acid |
| 653 | polymethyl methacrylate | acetic acid | palmitic acid | ammonium salt |
| 654 | polymethyl methacrylate | acetic acid | palmitic acid | potassium salt |
| 655 | polymethyl methacrylate | acetic acid | stearic acid | free acid |
| 656 | polymethyl methacrylate | acetic acid | stearic acid | ammonium salt |
| 657 | polymethyl methacrylate | acetic acid | stearic acid | potassium salt |
| 658 | polymethyl methacrylate | fumaric acid | montanic acid | free acid |
| 659 | polymethyl methacrylate | fumaric acid | montanic acid | ammonium salt |
| 660 | polymethyl methacrylate | fumaric acid | montanic acid | potassium salt |
| 661 | polymethyl methacrylate | fumaric acid | palmitic acid | free acid |
| 662 | polymethyl methacrylate | fumaric acid | palmitic acid | ammonium salt |
| 663 | polymethyl methacrylate | fumaric acid | palmitic acid | potassium salt |
| 664 | polymethyl methacrylate | fumaric acid | stearic acid | free acid |
| 665 | polymethyl methacrylate | fumaric acid | stearic acid | ammonium salt |
| 666 | polymethyl methacrylate | fumaric acid | stearic acid | potassium salt |
| 667 | polymethyl methacrylate | maleic acid | montanic acid | free acid |
| 668 | polymethyl methacrylate | maleic acid | montanic acid | ammonium salt |
| 669 | polymethyl methacrylate | maleic acid | montanic acid | potassium salt |
| 670 | polymethyl methacrylate | maleic acid | palmitic acid | free acid |
| 671 | polymethyl methacrylate | maleic acid | palmitic acid | ammonium salt |
| 672 | polymethyl methacrylate | maleic acid | palmitic acid | potassium salt |
| 673 | polymethyl methacrylate | maleic acid | stearic acid | free acid |
| 674 | polymethyl methacrylate | maleic acid | stearic acid | ammonium salt |
| 675 | polymethyl methacrylate | maleic acid | stearic acid | potassium salt |
| 676 | polymethyl methacrylate | malonic acid | montanic acid | free acid |
| 677 | polymethyl methacrylate | malonic acid | montanic acid | ammonium salt |
| 678 | polymethyl methacrylate | malonic acid | montanic acid | potassium salt |
| 679 | polymethyl methacrylate | malonic acid | palmitic acid | free acid |
| 680 | polymethyl methacrylate | malonic acid | palmitic acid | ammonium salt |
| 681 | polymethyl methacrylate | malonic acid | palmitic acid | potassium salt |
| 682 | polymethyl methacrylate | malonic acid | stearic acid | free acid |
| 683 | polymethyl methacrylate | malonic acid | stearic acid | ammonium salt |
| 684 | polymethyl methacrylate | malonic acid | stearic acid | potassium salt |
| 685 | polymethyl methacrylate | lactic acid | montanic acid | free acid |
| 686 | polymethyl methacrylate | lactic acid | montanic acid | ammonium salt |
| 687 | polymethyl methacrylate | lactic acid | montanic acid | potassium salt |
| 688 | polymethyl methacrylate | lactic acid | palmitic acid | free acid |
| 689 | polymethyl methacrylate | lactic acid | palmitic acid | ammonium salt |
| 690 | polymethyl methacrylate | lactic acid | palmitic acid | potassium salt |
| 691 | polymethyl methacrylate | lactic acid | stearic acid | free acid |
| 692 | polymethyl methacrylate | lactic acid | stearic acid | ammonium salt |
| 693 | polymethyl methacrylate | lactic acid | stearic acid | potassium salt |
| 694 | polymethyl methacrylate | oxalic acid | montanic acid | free acid |
| 695 | polymethyl methacrylate | oxalic acid | montanic acid | ammonium salt |
| 696 | polymethyl methacrylate | oxalic acid | montanic acid | potassium salt |
| 697 | polymethyl methacrylate | oxalic acid | palmitic acid | free acid |
| 698 | polymethyl methacrylate | oxalic acid | palmitic acid | ammonium salt |
| 699 | polymethyl methacrylate | oxalic acid | palmitic acid | potassium salt |
| 700 | polymethyl methacrylate | oxalic acid | stearic acid | free acid |
| 701 | polymethyl methacrylate | oxalic acid | stearic acid | ammonium salt |
| 702 | polymethyl methacrylate | oxalic acid | stearic acid | potassium salt |
| 703 | polymethyl methacrylate | tartaric acid | montanic acid | free acid |
| 704 | polymethyl methacrylate | tartaric acid | montanic acid | ammonium salt |
| 705 | polymethyl methacrylate | tartaric acid | montanic acid | potassium salt |
| 706 | polymethyl methacrylate | tartaric acid | palmitic acid | free acid |
| 707 | polymethyl methacrylate | tartaric acid | palmitic acid | ammonium salt |
| 708 | polymethyl methacrylate | tartaric acid | palmitic acid | potassium salt |
| 709 | polymethyl methacrylate | tartaric acid | stearic acid | free acid |
| 710 | polymethyl methacrylate | tartaric acid | stearic acid | ammonium salt |
| 711 | polymethyl methacrylate | tartaric acid | stearic acid | potassium salt |
| 712 | polymethyl methacrylate | citric acid | montanic acid | free acid |
| 713 | polymethyl methacrylate | citric acid | montanic acid | ammonium salt |
| 714 | polymethyl methacrylate | citric acid | montanic acid | potassium salt |
| 715 | polymethyl methacrylate | citric acid | palmitic acid | free acid |
| 716 | polymethyl methacrylate | citric acid | palmitic acid | ammonium salt |
| 717 | polymethyl methacrylate | citric acid | palmitic acid | potassium salt |
| 718 | polymethyl methacrylate | citric acid | stearic acid | free acid |
| 719 | polymethyl methacrylate | citric acid | stearic acid | ammonium salt |
| 720 | polymethyl methacrylate | citric acid | stearic acid | potassium salt |
| 721 | polybutyl methacrylate | formic acid | montanic acid | free acid |
| 722 | polybutyl methacrylate | formic acid | montanic acid | ammonium salt |
| 723 | polybutyl methacrylate | formic acid | montanic acid | potassium salt |
| 724 | polybutyl methacrylate | formic acid | palmitic acid | free acid |
| 725 | polybutyl methacrylate | formic acid | palmitic acid | ammonium salt |
| 726 | polybutyl methacrylate | formic acid | palmitic acid | potassium salt |
| 727 | polybutyl methacrylate | formic acid | stearic acid | free acid |
| 728 | polybutyl methacrylate | formic acid | stearic acid | ammonium salt |
| 729 | polybutyl methacrylate | formic acid | stearic acid | potassium salt |
| 730 | polybutyl methacrylate | ascorbic acid | montanic acid | free acid |
| 731 | polybutyl methacrylate | ascorbic acid | montanic acid | ammonium salt |
| 732 | polybutyl methacrylate | ascorbic acid | montanic acid | potassium salt |
| 733 | polybutyl methacrylate | ascorbic acid | palmitic acid | free acid |
| 734 | polybutyl methacrylate | ascorbic acid | palmitic acid | ammonium salt |
| 735 | polybutyl methacrylate | ascorbic acid | palmitic acid | potassium salt |
| 736 | polybutyl methacrylate | ascorbic acid | stearic acid | free acid |
| 737 | polybutyl methacrylate | ascorbic acid | stearic acid | ammonium salt |
| 738 | polybutyl methacrylate | ascorbic acid | stearic acid | potassium salt |
| 739 | polybutyl methacrylate | acetic acid | montanic acid | free acid |
| 740 | polybutyl methacrylate | acetic acid | montanic acid | ammonium salt |
| 741 | polybutyl methacrylate | acetic acid | montanic acid | potassium salt |
| 742 | polybutyl methacrylate | acetic acid | palmitic acid | free acid |
| 743 | polybutyl methacrylate | acetic acid | palmitic acid | ammonium salt |
| 744 | polybutyl methacrylate | acetic acid | palmitic acid | potassium salt |
| 745 | polybutyl methacrylate | acetic acid | stearic acid | free acid |
| 746 | polybutyl methacrylate | acetic acid | stearic acid | ammonium salt |
| 747 | polybutyl methacrylate | acetic acid | stearic acid | potassium salt |
| 748 | polybutyl methacrylate | fumaric acid | montanic acid | free acid |
| 749 | polybutyl methacrylate | fumaric acid | montanic acid | ammonium salt |
| 750 | polybutyl methacrylate | fumaric acid | montanic acid | potassium salt |
| 751 | polybutyl methacrylate | fumaric acid | palmitic acid | free acid |
| 752 | polybutyl methacrylate | fumaric acid | palmitic acid | ammonium salt |
| 753 | polybutyl methacrylate | fumaric acid | palmitic acid | potassium salt |
| 754 | polybutyl methacrylate | fumaric acid | stearic acid | free acid |
| 755 | polybutyl methacrylate | fumaric acid | stearic acid | ammonium salt |
| 756 | polybutyl methacrylate | fumaric acid | stearic acid | potassium salt |
| 757 | polybutyl methacrylate | maleic acid | montanic acid | free acid |
| 758 | polybutyl methacrylate | maleic acid | montanic acid | ammonium salt |
| 759 | polybutyl methacrylate | maleic acid | montanic acid | potassium salt |
| 760 | polybutyl methacrylate | maleic acid | palmitic acid | free acid |
| 761 | polybutyl methacrylate | maleic acid | palmitic acid | ammonium salt |
| 762 | polybutyl methacrylate | maleic acid | palmitic acid | potassium salt |
| 763 | polybutyl methacrylate | maleic acid | stearic acid | free acid |
| 764 | polybutyl methacrylate | maleic acid | stearic acid | ammonium salt |
| 765 | polybutyl methacrylate | maleic acid | stearic acid | potassium salt |
| 766 | polybutyl methacrylate | malonic acid | montanic acid | free acid |
| 767 | polybutyl methacrylate | malonic acid | montanic acid | ammonium salt |
| 768 | polybutyl methacrylate | malonic acid | montanic acid | potassium salt |
| 769 | polybutyl methacrylate | malonic acid | palmitic acid | free acid |
| 770 | polybutyl methacrylate | malonic acid | palmitic acid | ammonium salt |
| 771 | polybutyl methacrylate | malonic acid | palmitic acid | potassium salt |
| 772 | polybutyl methacrylate | malonic acid | stearic acid | free acid |
| 773 | polybutyl methacrylate | malonic acid | stearic acid | ammonium salt |
| 774 | polybutyl methacrylate | malonic acid | stearic acid | potassium salt |
| 775 | polybutyl methacrylate | lactic acid | montanic acid | free acid |
| 776 | polybutyl methacrylate | lactic acid | montanic acid | ammonium salt |
| 777 | polybutyl methacrylate | lactic acid | montanic acid | potassium salt |
| 778 | polybutyl methacrylate | lactic acid | palmitic acid | free acid |
| 779 | polybutyl methacrylate | lactic acid | palmitic acid | ammonium salt |
| 780 | polybutyl methacrylate | lactic acid | palmitic acid | potassium salt |
| 781 | polybutyl methacrylate | lactic acid | stearic acid | free acid |
| 782 | polybutyl methacrylate | lactic acid | stearic acid | ammonium salt |
| 783 | polybutyl methacrylate | lactic acid | stearic acid | potassium salt |
| 784 | polybutyl methacrylate | oxalic acid | montanic acid | free acid |
| 785 | polybutyl methacrylate | oxalic acid | montanic acid | ammonium salt |
| 786 | polybutyl methacrylate | oxalic acid | montanic acid | potassium salt |
| 787 | polybutyl methacrylate | oxalic acid | palmitic acid | free acid |
| 788 | polybutyl methacrylate | oxalic acid | palmitic acid | ammonium salt |
| 789 | polybutyl methacrylate | oxalic acid | palmitic acid | potassium salt |
| 790 | polybutyl methacrylate | oxalic acid | stearic acid | free acid |
| 791 | polybutyl methacrylate | oxalic acid | stearic acid | ammonium salt |
| 792 | polybutyl methacrylate | oxalic acid | stearic acid | potassium salt |
| 793 | polybutyl methacrylate | tartaric acid | montanic acid | free acid |
| 794 | polybutyl methacrylate | tartaric acid | montanic acid | ammonium salt |
| 795 | polybutyl methacrylate | tartaric acid | montanic acid | potassium salt |
| 796 | polybutyl methacrylate | tartaric acid | palmitic acid | free acid |
| 797 | polybutyl methacrylate | tartaric acid | palmitic acid | ammonium salt |
| 798 | polybutyl methacrylate | tartaric acid | palmitic acid | potassium salt |
| 799 | polybutyl methacrylate | tartaric acid | stearic acid | free acid |
| 800 | polybutyl methacrylate | tartaric acid | stearic acid | ammonium salt |
| 801 | polybutyl methacrylate | tartaric acid | stearic acid | potassium salt |
| 802 | polybutyl methacrylate | citric acid | montanic acid | free acid |
| 803 | polybutyl methacrylate | citric acid | montanic acid | ammonium salt |
| 804 | polybutyl methacrylate | citric acid | montanic acid | potassium salt |
| 805 | polybutyl methacrylate | citric acid | palmitic acid | free acid |
| 806 | polybutyl methacrylate | citric acid | palmitic acid | ammonium salt |
| 807 | polybutyl methacrylate | citric acid | palmitic acid | potassium salt |
| 808 | polybutyl methacrylate | citric acid | stearic acid | free acid |
| 809 | polybutyl methacrylate | citric acid | stearic acid | ammonium salt |
| 810 | polybutyl methacrylate | citric acid | stearic acid | potassium salt |

The present invention is not limited to embodiments described herein; reference should be had to the appended claims.

1-15. (canceled)

16. A formulation of at least one of a partially and a fully stabilized zirconium oxide powder, the formulation comprising at least one organic auxiliary substance, wherein a pressing pressure so as to obtain a green density of at least 50% of a theoretical density is 200 MPa or less and a cohesiveness is 0.7 or more.

17. The formulation as recited in claim 16, wherein the pressing pressure is 150 MPa or less.

18. The formulation as recited in claim 16, wherein a force to destroy a compact in an axial direction and a radial direction is 10 MPa or more.

19. The formulation as recited in claim 16, wherein the at least one organic auxiliary substance is at least one carboxylic acid.

20. The formulation as recited in claim 19, wherein the at least one carboxylic acid is present in an amount of from 0.1 to 5 wt. %.

21. The formulation as recited in claim 19, wherein the at least one carboxylic acid has a melting point of from 35° C. to 100° C.

22. The formulation as recited in claim 16, wherein the at least one of a partially and a fully stabilized zirconium oxide powder is a zirconium oxide with a monoclinic phase content of 30% or more.

23. The formulation as recited in claim 16, wherein the at least one of a partially and a fully stabilized zirconium oxide powder is a zirconium oxide with a monoclinic phase content of 90% or less

24. The formulation as recited in claim 16, wherein the formulation has a specific surface area after a removal of the at least one organic auxiliary substance of between 3 and 50 M²/g.

25. The formulation as recited in claim 16, wherein the formulation is obtained from an aqueous dispersion.

26. A process for preparing a zirconium oxide formulation, the process comprising:
providing a zirconium oxide and a solvent;
providing at least one carboxylic acid;
providing at least one binder; and
adding the at least one carboxylic acid and the at least one binder to the zirconium oxide in a presence of the solvent.

27. The process as recited in claim 26, wherein the solvent is water.

28. The process as recited in claim 26, wherein the zirconium oxide is provided as at least one of a suspension and a dispersion, the at least one carboxylic acid is provided as at least one of a solution, a suspension and a dispersion, and the binder is provided as at least one of a solution, a suspension and a dispersion,
and wherein the process comprises:
adding the at least one carboxylic acid to the zirconium oxide provided as at least one of a suspension and a dispersion to obtain a first suspension or dispersion as an intermediate product;
adding the binder to the first suspension or dispersion to obtain a second dispersion; and further comprising
drying the second dispersion to obtain granules.

29. The process as recited in claim 28, wherein a solvent in the zirconium oxide dispersion is water.

30. The process as claimed in claim 26, wherein the zirconium oxide is provided as at least one of a suspension and a dispersion, the at least one carboxylic acid is provided as at least one of a short-chained carboxylic acid provided as at least one of a solution, a suspension and a dispersion and a long-chained carboxylic acid provided as at least one of a solution, a suspension and a dispersion, and the binder is provided as at least one of a solution, a suspension and a dispersion,
and wherein the process comprises:
adding the short-chained carboxylic acid to the zirconium oxide provided as at least one of a suspension and a dispersion to obtain a first suspension or dispersion as a first intermediate product;
adding the long-chained carboxylic acid to the first suspension or dispersion to obtain a second suspension or dispersion as a second intermediate product;
adding the binder to the second suspension or dispersion to obtain a third dispersion; and further comprising
drying the third dispersion to obtain granules.

31. The process as recited in claim 30, wherein a solvent in the zirconium oxide dispersion is water.

32. The process as recited in claim 26, wherein the zirconium oxide is provided as at least one of a suspension or dispersion, the at least one carboxylic acid is provided as a short-chained carboxylic acid provided as at least one of a solution, a suspension and a dispersion and as a long-chained carboxylic acid provided as at least one of a solution, a suspension and a dispersion, and the binder is provided as at least one of a solution, a suspension and a dispersion, and wherein the process comprises:
adding the short-chained carboxylic acid to the zirconium oxide provided as at least one of a suspension and a dispersion to obtain a first suspension or dispersion as a first intermediate product;
adding the long-chained carboxylic acid to the first suspension or dispersion to obtain a second suspension or dispersion as a second intermediate product;
adding the binder to the second suspension or dispersion to obtain a third dispersion; and further comprising
drying the third dispersion to obtain granules,
wherein the adding of the long-chained carboxylic acid, the short-chained carboxylic acid and the binder are each carried out at a temperature of less than 50° C. and at a pH of from 8 to 12.

33. The process as recited in claim 32, wherein a solvent in the zirconium oxide dispersion is water.
